(19) United States
(12) Patent Application Publication
(10) Pub. No.: US 2011/0248119 A1
(43) Pub. Date: Oct. 13, 2011

(54) STRUCTURAL CONNECTORS AND METHODS OF USING SAME

(76) Inventors: Israel Stol, Pittsburgh, PA (US); John W. Cobes, JR., Lower Burrell, PA (US)

(21) Appl. No.: 12/756,263

(22) Filed: Apr. 8, 2010

(51) Int. Cl. B64C 1/00; E04B 1/38; F16B 7/00

(52) U.S. Cl. 244/131; 403/170; 52/655.1

(57) ABSTRACT

Structural connectors for watercrafts, buildings and aircrafts are disclosed. In general, each structural connector includes at least a pair of members extending outwardly from and substantially perpendicular to a body of the structural connector, the members spaced apart from one another so as to form a recess therein between. In some embodiments, the recess may be sized and shaped for receiving supporting members including the likes of stringers and support plates.

### BACKGROUND

FIGS. 1-4 illustrate some of the challenges associated with the conventional approach to forming leak-proof compartments of a watercraft such as a ship or boat. FIG. 1 is a cross-section view of a portion of a ship showing corrugated bulkhead 102 having top 104, side 106, and base 108. FIGS. 2-4 are perspective and cross-section views of the base 108 of the corrugated bulkhead 102. Although the illustrations in FIGS. 2-4 are directed to the base 108, it will be appreciated that the issues related to the base 108 are equally applicable to the top 104 and the side 106, as well as other areas of the bulkhead 102 or compartments throughout the ship.

FIGS. 2-3 are assembled views of the base 108 of the corrugated bulkhead 102. In general, the base 108 includes corrugated base 114 attached to the corrugated bulkhead 102 by gas metal arc (GMA) welding tee-fillet joints 202 as shown by the dashed line. In some embodiments, the corrugated base 114 may be attached to the corrugated bulkhead 102 via other suitable coupling techniques including welding, bolting and mechanical fasteners, to name a few.

The corrugated base 114 includes a plurality of rate holes 112 through which stringers 110 may be passed therethrough as best illustrated in FIG. 2. The stringers 110 are designed for supporting and/or strengthening the ship and may be welded to the corrugated base 114 using GMA welding joints 204 or other coupling techniques discussed above. The stringer 110 may also be secured by the use of sealing plates 116, which may be used to cover the rate holes 112 through which stringers 110 may be passed therethrough the corrugated base 114 to seal any potential leaks (e.g., fuel). The sealing plate 116 may be welded to the corrugated base 114 using GMA welding joints 208, among other coupling techniques. Similarly, the sealing plates 116 may be welded to the stringer 110 using GMA welding joints 206, among other coupling techniques. In securing the sealing plate 116 to both the stringer 110 and the corrugated base 114, the sealing plate 116 may be able to substantially seal or prevent leaks (e.g., fuel) throughout compartments within the bulkhead 102 of the ship. In addition, both the stringer 110 and the sealing plate 116 may also be welded to the hull 118 of the ship using GMA welding joints 210, among other coupling techniques. When fully assembled, each stringer 110 may be placed at predetermined distances (e.g., about 25 feet apart) from one another at the base 108 of the bulkhead 102 to provide added support for the ship as best illustrated in FIG. 3.

FIG. 4 is a cross-sectional view through portions of the stringer 110, sealing plate 116, corrugated base 114, and hull 118. As previously discussed, stringers 110 may be welded to the corrugated base 114 and further secured with the sealing plate 116. However, because of the design of the stringers 110 and the conventional GMA welding techniques associated therewith, sharp transitions may be formed about the GMA weld joints 204, 206 between the stringer 110 and the sealing plate 116, and between the stringer 110 and the corrugated base 114, as best illustrated by the arrows of FIG. 4. These sharp transitions may give rise to crack formation propensities due to non-uniform welds, among other issues. Accordingly, the conventional approach of connecting stringers 110 to bulkheads 102 may not only be troublesome and costly, but may also bring about the following challenges, among others:

(1) Forming welding joints between sealing-cover plate, bulkhead and stringer may be difficult via manual GMA welding techniques.

(2) The quality of the GMA welding joints may be vary depending on the skills of the welding operator, which may be difficult to maintain uniformly throughout and across shipyards.

(3) Training and qualifying manual welding operators may be costly and timely, and may also be difficult to retain due to fierce competition in the marketplace for skilled welders.

(4) Visual inspection of leakage at welds between parts may be difficult without costly leak-tests under pressure. Once leaks are discovered, it may be necessary to dry the affected welds, remove them, re-weld them, and re-test for leaks under pressure. The conventional leak detection and repair operations may be costly and time consuming.

(5) Even without detectable leaks, liquids (e.g., diesel fuel) may nevertheless seep along welds between the stringers and the hull, among other places. Prevention may require grinding of partially welded joints, which may be time consuming and costly to implement.

(6) Repairs to welds when the ship is in operation may be costly and at times dangerous out in the open sea than in shipyards while the ship is being built.

(7) Designs of the joints to be welded between the bulkhead, sealing plates and stringers may be prone to premature failures because the welds are located at sharp and abrupt transitions, which may act as stress intensifiers (e.g., stress-risers) on the welds. In time, the weld joints may become over-stressed and may be more likely to fail after shorter periods of service on the sea when subjected to cyclic loading. In addition, different welders performing manual GMA welds may have somewhat differing welding procedures, which may entail different welding heat input into the parts. The great variability in the quality of the welds and the width and strengths of the heat affected zones (HAZs) adjoining the welds may combine to compromise (e.g., reduce) the structural performance of the welds in service (e.g., fatigue). Furthermore, welds located at sharp and abrupt transitions may induce residual stresses, which may cause solidification shrinkage and expansion/contraction cycles of weldments during welding, which further augments the stressing of the welds in service. The combination of stresses with the geometrically sharp transitions may lead to shortened life on the high seas.

(8) Opposing welds between the sealing plates and the arms (e.g., webs and flanges) of the stringers may result in the formation of overlapping and coalescing HAZs within the stringers, which may weaken the stringers at the sections that pass through the bulkheads. The weakening of the stringers may act to reduce the load transmitting capability in the area.

### SUMMARY

Structural connectors for watercrafts, buildings and aircrafts are disclosed. In one embodiment, a structural connector for watercraft includes a body adapted to be coupled to a partition element of the watercraft such as a bulkhead. The structural connector further includes first and second members that extend outwardly from and substantially perpendicular with respect to the body along the same direction, the first and second members being spaced apart from one another so as to form a first recess therein between. In one embodiment, the first recess may be sized and shaped for receiving a first supporting member of the watercraft such as a stringer.

Substantially similar third and fourth members may be attached to the structural connector on opposite side of the first and second members, the third and fourth members also extending outwardly from and substantially perpendicular with respect to the body along a direction opposite that of the first and second members. Like the first and second members, the third and fourth members may be spaced apart from one another so as to form a second recess therein between. And like the first recess, the second recess may be sized and shaped for receiving a second supporting member of the watercraft such as a stringer.

In one embodiment, the members may have substantially L-shaped cross sections, although other shapes including the likes of curved shape, rectangular shape and square shape, among suitable polygonal shapes, may be contemplated for forming the recesses.

In one embodiment, a substrate may be attached to the structural connector, the substrate extending substantially perpendicular with respect to the body and the four members. In some instances, the substrate may be positioned so as to enclose a portion of each of the two recesses. In other instances, the substrate may be adapted to be coupled to a base of the watercraft such as a hull.

In some embodiments, the body of the structural connector includes a first surface, a second surface opposite the first surface, and an interface intermediate the first surface and the second surface. In these instances, the interface may be welded to the partition element (e.g., bulkhead), while the first and second members may be attached to the first surface and the third and fourth members may be attached to the second surface.

In some embodiments, the body of the structural connector may be coupled to the partition element by attaching with fasteners, adhesives, welding, bolting or combinations thereof, among other suitable coupling techniques. The substrate may be similarly coupled to the base by these techniques.

In one embodiment, an additional body and an additional substrate may be incorporated in the structural connector. For example, the body discussed above may be a first body and in one embodiment, a second body may be longitudinally spaced with respect to the first body, the second body configured to be coupled to the partition element such as the bulkhead of the ship. Likewise, in one embodiment, the substrate discussed above may be a first substrate and a second substrate may be incorporated in the structural connector, the second substrate coupled to and extending substantially perpendicular with respect to the second body.

In one embodiment, corresponding fifth and sixth members may be attached to a first surface of the second body, the fifth and sixth members extending outwardly from and substantially perpendicular with respect to the second body, whereby the fifth and sixth members may be shaped and sized to form a third recess therein between. In another embodiment, seventh and eighth members may be attached to a second surface of the second body, the seventh and eighth members extending outwardly from and substantially perpendicular with respect to the second body, whereby the seventh and eighth members may be shaped and sized to form a fourth recess therein between. In some embodiments, the seventh and eighth members are extending in opposite direction of the fifth and sixth members. In other words, the third and fourth recesses may be formed on opposite sides of the second body (e.g., third recess on the first surface, fourth recess on the second surface). Like above, the third and fourth recesses may be sized and shaped for receiving supporting members of watercrafts such as stringers. In addition, a portion of each of the third and fourth recesses may be enclosed by the second substrate, with the second substrate being adapted to be coupled to the base or hull of the watercraft.

In one embodiment, a structural connector for a building includes a body having a top surface and a bottom surface, where at least one of the top and bottom surfaces is adapted to be coupled to a first support structure of the building such as beams, columns or girders.

In one example, first and second members may be attached to the body, the first and second members extending outwardly from and substantially perpendicular with respect to the body along a first direction. In this example, the first and second members may be spaced apart from one another so as to form a first recess therein between. In one embodiment, the first recess may be sized and shaped for receiving a second support structure such as beams, columns or girders. Adjacent the first and second members is a first ledge, which also extends substantially perpendicular with respect to the body along a substantially similar direction as the first and second members. In some instances, the first ledge may be designed to support the weight of the second support structure.

In another example, third and fourth members may be attached to the body, the third and fourth members extending outwardly from and substantially perpendicular with respect to the body along a second direction, which need not be the same as the first direction. In this example, the third and fourth members may be spaced apart from one another so as to form a second recess therein between. Like the first recess, the second recess may also be sized and shaped for receiving a third support structure such as beams, columns or girders. Adjacent the third and fourth members is a second ledge, which also extends substantially perpendicular with respect to the body along a similar direction as the third and fourth members. In some instances, the second ledge may be designed to support the weight of the third support structure.

In one embodiment, the body of the structural connector may have a first surface and a second surface that is different from the first surface. The first ledge and the first and second members may be attached to the first surface while the second ledge and the third and fourth members may be attached to the second surface using the coupling techniques described above. In some embodiments, the body may have substantially I-shaped cross sections, although other shapes including the likes of C-shape, rectangular shape and square shape, among other suitable polygonal shapes, may be contemplated for forming the body. Likewise, although the members have substantially I-shaped cross sections, other shapes including the likes of C-shape, L-shape, T-shape and planar shape, among other suitable polygonal shapes may be contemplated for use in forming the members. Similarly, although the ledges have substantially L-shaped cross sections, other shapes including the likes of C-shape, I-shape, T-shape and planar shape, among other suitable polygonal shapes, may be contemplated for use in forming the ledges.

Optionally, a first plate may be adapted to be coupled to the body adjacent the first and second members while a second plate may be adapted to be coupled to the body adjacent the third and fourth members. In some embodiments, the plates may be operable to secure the support structures from rotating or slipping or both. Furthermore, gussets may be adapted to be coupled to the ledges to further support the weight of the support structure exerted on the ledges.

In one embodiment, a structural connector for an aircraft includes a body having a first surface, a second surface opposite the first surface, and an edge between the first surface and the second surface. In this example, a portion of the edge may be adapted to interface with a recess of a plate of the aircraft such as a web plate or support plate.

A first member may be attached to the first surface of the body, the first member extending outwardly from and substantially perpendicular with respect to the body in a first direction while a second member may be attached to the second surface of the body, the second member extending outwardly from and substantially perpendicular with respect to the body in a second direction. In some instances, the first and second directions are opposite each other.

Each of the opposite, outwardly extending members may have a free end that may be adapted to be coupled to supporting members of the aircraft such as stringers. For example, the free end of the first member may be welded to a first supporting member while the free end of the second member may be welded to a second supporting member.

In some embodiments, although the members have substantially T-shaped cross sections, other shapes including the likes of C-shape, I-shape, L-shape, triangular shape and rectangular shape, among other suitable polygonal shapes, may be contemplated for use in forming the members.

In addition, a structure may be attached to the body, the structure extending substantially perpendicular with respect to the body and adapted to interface with a portion of the edge such that the structure may be flush with the plate of the aircraft. The edge adapted to interface with the recess may be attached to the same with fasteners or adhesives or by welding or bolting, among other coupling techniques. Similarly, the structure adapted to interface with the edge may be attached to the samewith fasteners or adhesives or by welding or bolting, among other coupling techniques.

Other variations, embodiments and features of the present disclosure may become more evident from the following detailed description, drawings and claims.

### BRIEF DESCRIPTION OF THE DRAWINGS

FIGS. 1-4 illustrate conventional approaches of attaching stringers to bulkheads and hull of a ship;

FIG. 5 is a perspective view of a structural connector of a watercraft according to one embodiment of the present disclosure;

FIGS. 6-7 are exploded and assembled views of a structural connector attached to bulkhead and hull of a watercraft;

FIGS. 8-9 are perspective views of a structural connector attached to bulkhead and hull of a watercraft;

FIGS. 10-11 are cross-section views of a structural connector and various attachment configurations to bulkhead and hull of a watercraft;

FIG. 12 is a perspective view of a structural connector of a watercraft according to one embodiment of the present disclosure;

FIGS. 13-14 are exploded and assembled views of a structural connector attached to bulkhead and hull of a watercraft;

FIG. 15 is a perspective view of a structural connector assembly according to one embodiment of the present disclosure;

FIGS. 16A-16C illustrate conventional approaches of connecting beams and columns of a building;

FIGS. 17A-17C illustrate perspective views of a structural connector of a building according to one embodiment of the present disclosure;

FIGS. 18-19 illustrate structural connectors of a building according to embodiments of the present disclosure;

FIGS. 20A-20C illustrate conventional approaches of connecting stringers to support structures of an airplane;

FIG. 21 is a perspective view of a structural connector of an aircraft according to one embodiment of the present disclosure;

FIG. 22 illustrates an assembled view of a structural connector to a web plate of an aircraft;

FIG. 23 is a perspective view of a structural connector of an aircraft according to one embodiment of the present disclosure;

FIG. 24 illustrates an assembled view of a structural connector to a web plate of an aircraft; and

FIGS. 25-26 illustrate assembled views of a structural connector attached to a wing of an aircraft with and without skin panels.

### DETAILED DESCRIPTION

It will be appreciated by those of ordinary skill in the art that the disclosure can be embodied in other specific forms without departing from the spirit or essential character thereof. The presently disclosed embodiments are therefore considered in all respects to be illustrative and not restrictive.

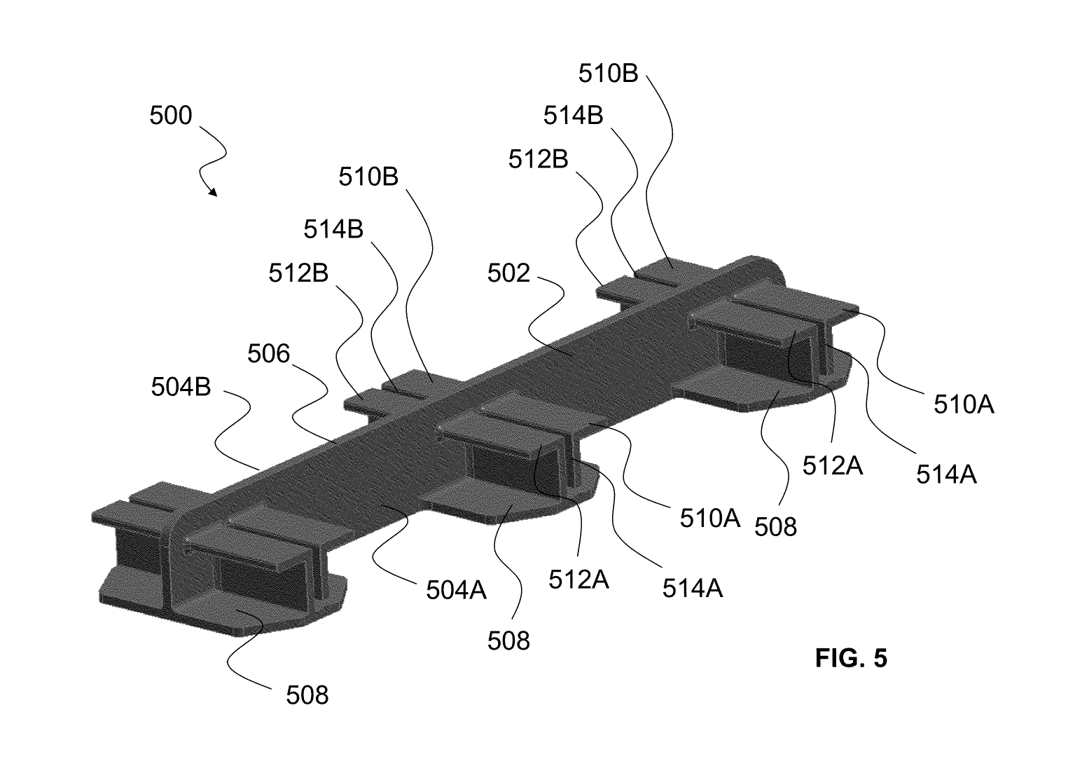

FIGS. 5-10 illustrate examples of structural connectors 500 for forming leak-proof compartments of a watercraft such as a ship or boat. FIG. 5 shows a structural connector 500 having a generally elongated body 502. In this example, the body 502 has a substantially rounded rectangular shape although the body 502 can take on other polygonal shapes as contemplated including without limitation rectangular, square, and rounded square. The structural connector 500 may be fabricated of stainless steel, aluminum alloy or other suitable materials. Furthermore, the structural connector 500 may be forged, cast or machined.

In one embodiment, the body 502 includes a first surface 504A, a second surface 504B opposite the first surface 504A, and an interface surface 506 intermediate the first surface 504A and the second surface 504B. A first member 510A may be attached to the first surface 504A whereby the first member 510A extends outwardly from and substantially perpendicular with respect to the body 502. In this instance, the first member 510A is capable of extending from the first surface 504A of the body 502 in a substantially lateral direction to the right of the longitudinal body 502. A second member 512A, adjacent the first member 510A, may be similarly attached to the first surface 504A whereby the second member 512A extends outwardly from and substantially perpendicular with respect to the body 502. Like the first member 510A, the second member 512A is also capable of extending from the first surface 504A of the body 502 in a substantially lateral direction to the right of the longitudinal body 502. In general, the first and second members 510A, 512A are configured to extend substantially perpendicular with respect to the body 502 along a substantially similar direction (e.g., in this instance, toward the right side of the longitudinal body 502).

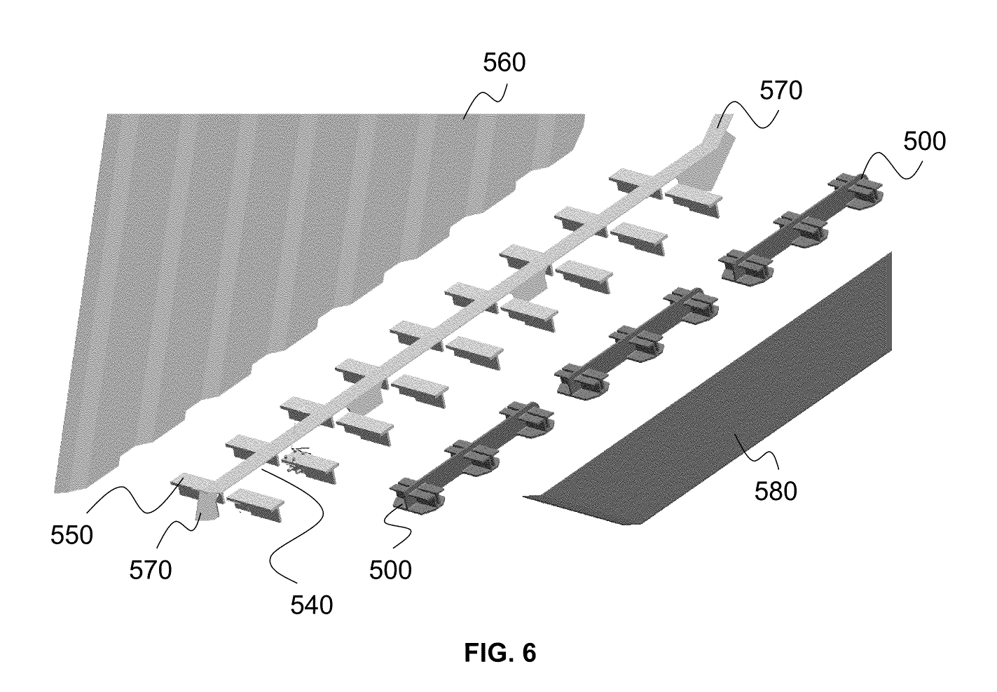

Although adjacent to one another, the first and second members 510A, 512A may be substantially spaced apart from one another so as to form a first recess 514A therein between. In one embodiment, the first recess 514A has substantially straight side walls due to the first and second members 510A, 512A having substantially vertical features or dimensions. In some embodiments, the first recess 514A may be accordingly tapered, angled or curved due to tapering, angling or curvature of the first and second members 510A, 512A. Regardless of the configuration or dimension of the first recess 514A, the first recess 514A may, in an embodiment, be substantially sized and shaped for receiving a supporting member 550 (FIG. 6) of a watercraft such as a stringer. This will become more apparent in subsequent figures and discussion.

Although three sets of members 510A, 512A are situated on the first surface 504A as shown in FIG. 5, there can be more or fewer members 510A, 512A depending on the design requirements of the structural connector 500. For example, there can be one or two sets of members 510A, 512A disposed about the first surface 504A of the body 502 whereby the body 502 may be sized and shaped accordingly (e.g., reduce longitudinal length of the body 502 to accommodate fewer members 510A, 512A). Conversely, there may be four, five, six or more sets of members 510A, 512A whereby the longitudinal body 502 may be elongated accordingly to accommodate additional members 510A, 512A.

Opposite the first and second members 510A, 512A of the first surface 504A are corresponding third and fourth members 510B, 512B that may be attached to the second surface 504B, this set of members 510B, 512B being substantially similar to the set of members 510A, 512A attached to the first surface 504A. For example, a third member 510B may be attached to the second surface 504B, the third member 510B extending outwardly from and substantially perpendicular with respect to the longitudinal body 502 in a substantially left lateral direction. Likewise, a fourth member 512B may be attached to the second surface 504B, the fourth member 512B extending outwardly from and substantially perpendicular with respect to the longitudinal body 502 in a substantially lateral direction to the left, whereby the third and fourth members 510B, 512B are generally configured to extend substantially perpendicular to the body 502 along a substantially similar direction. In this instance, the third and fourth members 510B, 512B are extending along opposite direction of the first and second members 510A, 512A.

Likewise, the third and fourth members 510B, 512B are adjacent one another and substantially spaced apart from one another so as to form a second recess 514B therein between. Like the first recess 514A, the second recess 514B may have straight, tapered, curved or angled sidewalls, and be substantially sized and shaped for receiving a supporting member 550 such as a stringer of the watercraft, and will become more apparent in subsequent figures and discussion.

A substrate 508 may be attached to portions of the body 502 and the members 510, 512, the substrate 508 capable of extending substantially perpendicular with respect to the body 502 and the members 510, 512. In some instances, the substrate 508 may be similar to that of a base of the structural connector 500. Although multiple substrates 508 are shown, these substrates 508 may be integrated or formed into a single unitary substrate 508 (not shown). In other words, the substrates 508 may be an elongated, longitudinal structure situated at the base portion of the structural connector 500. In some embodiments, the substrate 508 may take on other configurations and shapes including square, rectangle and circle, to name a few.

In one embodiment, the substrate 508 may be positioned so as to enclose a portion of each of the first and second recesses 514A, 514B. For example, the recesses 514 as shown are formed by L-shaped members 510, 512 leaving openings at the top and bottom of the recesses 514. Incorporating the substrate 508 allows bottom portions of the recesses 514 to be substantially enclosed while leaving the top sections of the recesses 514 open for receiving supporting members 550 of the watercraft. In some instances, the recesses 514 may be formed by members 510, 512 having curved shape, rectangular shape, or square shape (not shown). In other instances, the recesses 514 may be formed by members 510, 512 configured in other polygonal shapes.

In one embodiment, the bottom of the substrate 508 may be coupled to a base 580 of a watercraft such as a hull. This will become more apparent in subsequent figures and discussion.

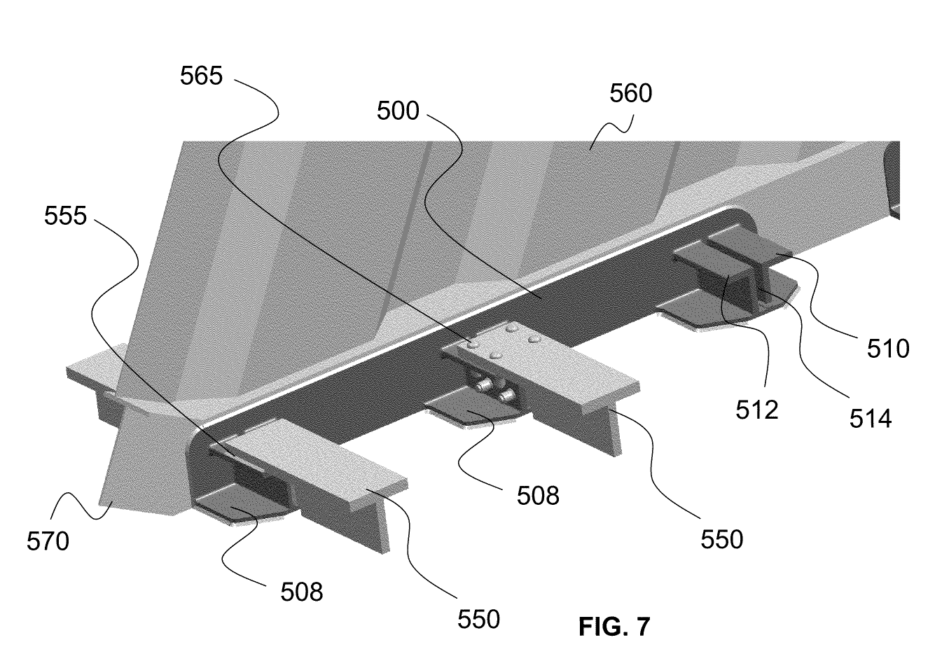

FIGS. 6-7 illustrate exploded and assembled views of the structural connector 500 attached to bulkhead 560, 570 and hull 580 of a watercraft for forming leak-proof compartments. In one embodiment, the structural connectors 500 may be attached to the bulkhead 560, 570 and the hull 580 by welding or bolting or both techniques. In some embodiments, the structural connectors 500 may be coupled to the bulkhead 560, 570 and the hull 580 by other suitable coupling techniques.

For example, the structural connectors 500 may be welded to the bulkhead 560, 570 and the hull 580 by various arc welding processes including the likes of gas metal arc welding, gas tungsten arc welding, friction stir welding, and metal inert gas welding, among others. The welding processes may be capable of producing weld joints including the likes of butt joint (e.g., square butt joint, v-butt joint, double-vee joint), lap joint, corner joint, edge joint, T-joint, and filet weld, to name a few. In some instances, the weld joints may be capable of merging into the parts (e.g., structural connectors 500, bulkhead 560, 570, hull 580) to form continuous weldments. In other instances, consistent and controlled welds may be formed with smaller HAZs (e.g., narrower, stronger) due to the use of fewer weld passes, which may reduce the welding heat input into these areas. The welds between the structural connectors 500 and the bulkhead 560, 570 and the hull 580 may prevent fluids from passing therethrough in forming leak-proof compartments.

Alternatively, the structural connectors 500 may be mechanically attached to the bulkhead 560, 570 and the hull 580 with fasteners or adhesives or both. In some embodiments, fasteners include rivets, bolts, adhesives, and sealants, to name a few. In other embodiments, combinations of welding, bolting, fasteners and adhesives, among other mechanical coupling techniques, may be incorporated for attaching the structural connectors 500 to the bulkhead 560, 570 and the hull 580.

In one embodiment, the bulkhead 560, 570 includes corrugated bulkhead 560 and bulkhead base 570, whereby the bulkhead base 570 may be welded or fastened underneath the corrugated bulkhead 560 using the techniques described above. In another embodiment, the corrugated bulkhead 560 and the bulkhead base 570 may be integrated as a single unit. In some embodiments, a watercraft may contain multiple corrugated bulkheads 560, which may incorporate different configurations and function to partition or divide the watercraft into various compartments. In other words, bulkheads 560, 570 may function as separators or partition elements to divide portions of the ship into different compartments.

As shown in the exploded view of FIG. 6, the bulkhead base 570 may include a plurality of openings 540 whereby each opening 540 may be designed to receive a structural connector 500. The structural connector 500 may be received within the opening 540 by the techniques described above including without limitation welding, bolt, or attaching with fasteners or adhesives as best illustrated in the assembled view of FIG. 7. Additional details on the structural connector 500 and its relationship with the bulkhead 560, 570 will be provided in subsequent figures and discussion.

As shown in the assembled view of FIG. 7, the structural connector 500 may be positioned within the opening 540 by the coupling methods discussed above. Once situated therein, the recesses 514 formed by the members 510, 512 may function like a saddle to receive stringers 550 of a ship. As shown, the recesses 514 may receive a bottom flange (e.g., web) of the T-shaped stringers 550. In one embodiment, stringer 550 may be welded to the structural connector 500 via weld joints 555. In another embodiment, stringer 550 may be attached to the structural connector 500 via rivets, huck fasteners, or bolts 565. In some embodiments, combination of the two, among the coupling techniques discussed above, may be incorporated.

In some embodiments, stringers 550 may be designed to support, stiffen and/or strengthen the ship. When attached, stringers 550 may be in communication with the bulkhead 560, 570 and the hull 580. During operation when external forces such as ocean waves are exerted against the hull 580, the forces may be transferred to the stringers 550 via the structural connectors 500. In some instances, stringers 550 may absorb loads or longitudinal/lateral stresses resulting from bending or flexing forces that may be exerted against the bulkhead 560, 570 and the hull 580. In other instances, stringers 550 may take up radial forces along with other external forces (e.g., ocean waves, debris in the water) that may be exerted against the bulkhead 560, 570 and the hull 580.

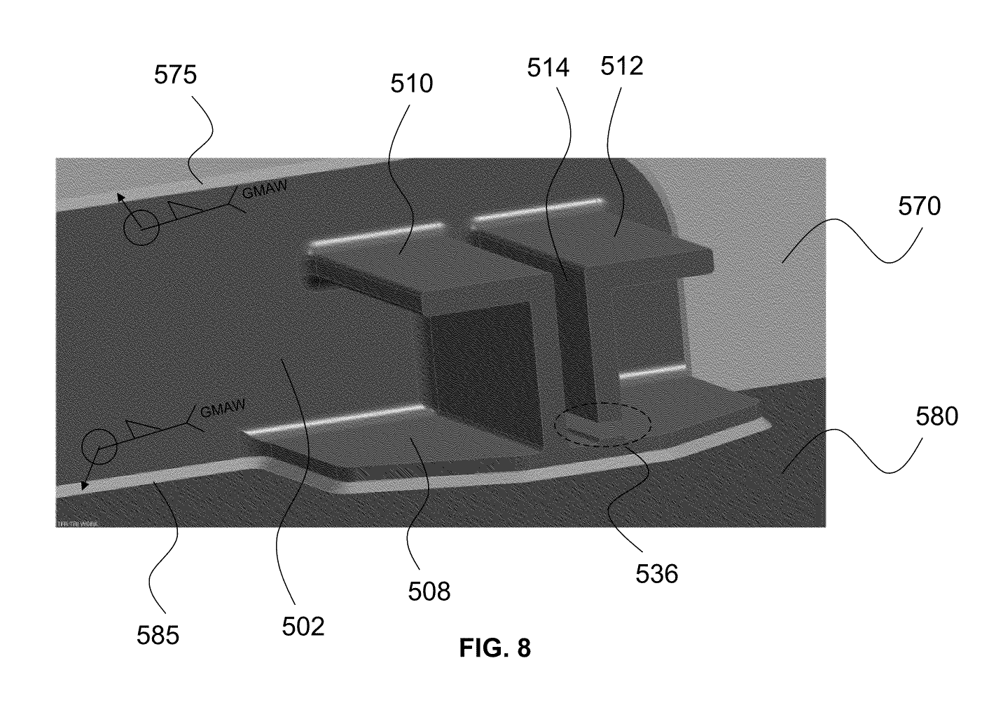

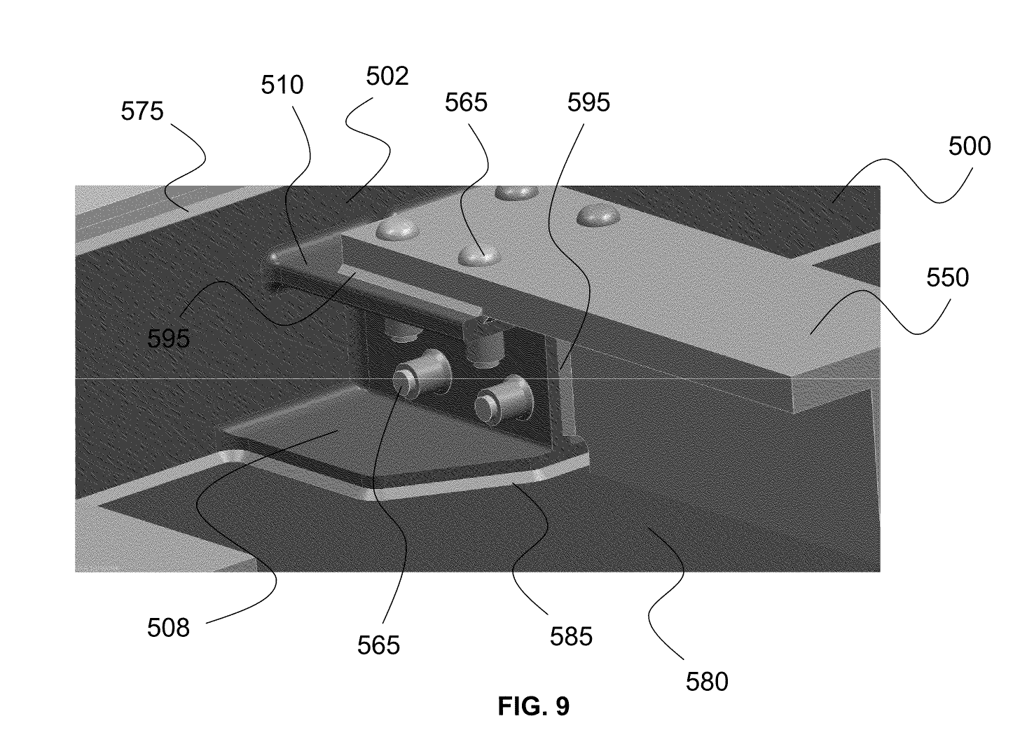

FIGS. 8-9 are close-up perspective views of the connector 500 and its relationship to the bulkhead base 570 and the hull 580 of the ship. As discussed above, the L-shaped members 510, 512 of the structural connector 500 may be configured as to form a recess 514 therein between. In one example, the members 510, 512 may be curved into the body 502 of the structural connector 500 at a radius for improved fatigue.

As shown in FIG. 8, a bottom portion of the member 512 may be detached from the body 502 of the structural connector 500 to produce a side slot 536. In one embodiment, the side slot 536 may improve compliancy and physical contact between the structural connector 500 and a stringer 550 upon insertion of the stringer 550 within the recess 514 of the members 510, 512. For example, the side slot 356 may be designed to impart flexibility and sufficient compliancy to the walls 510, 512 that form the recess 514 for accepting the vertical flange of a stringer 550, such that upon bolting and/or welding of the stringer 550 to the members 510, 512, any resulting gaps, if any, may be substantially reduced so that the parts 510, 512, 550 maintain intimate continuous, physical contact. In some embodiments, the side slot 356 may substantially enclose two gaps, the first gap being between the first member 510 and one side of the vertical flange of the stringer 550 and the second gap being between the second member 512 and the opposite side of the vertical flange of the stringer 550. Closing of the gaps may improve the control over dimensional tolerances during the assembly of the parts 510, 512, 550 to each other and thereby substantially improve the fatigue lifetime of the joints in service.

In one embodiment, the body 502 of the structural connector 500 may be received within the opening 540 and attached to the bulkhead base 570 via continuous weld 575. In some instances, the continuous weld 575 may be a friction stir or GMA welded square butt-joint.

Likewise, the substrate 508, as well as a portion of the body 502, may be attached to the hull 580 using similar welds 585. In one embodiment, the continuous weld 585 may be a GMA welded lap-fillet joint between the substrate 508 of the structural connector 500 and the hull 580.

Once the structural connector 500 has been secured to the bulkhead base 570 and the hull 580 of the ship, stringer 550 may be received within and attached to the recess 514 via the coupling techniques discussed above. For example, the stringer 550 may be attached to the members 510, 512 with continuous welds 595. In some embodiments, the continuous welds 595 may be GMA welded lap-fillet joints.

In some embodiments, further reinforcement of the stringer 550 to the members 510, 512 may be provided by bolt fasteners 565 including the likes of huck-bolts, huck fasteners, among others. Optionally, the base of the stringer 550 may be attached to the hull 580 via continuous welds or remain unwelded as shown in FIG. 9.

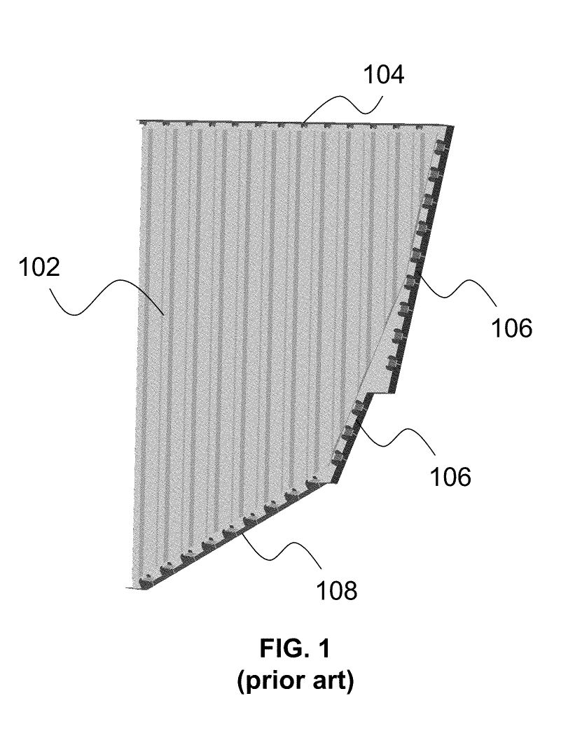

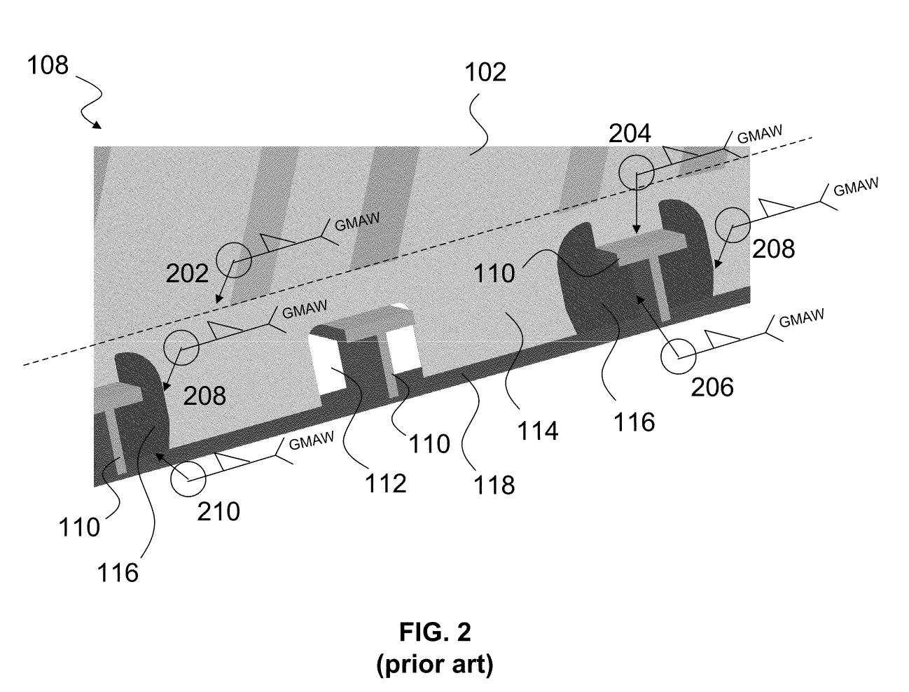

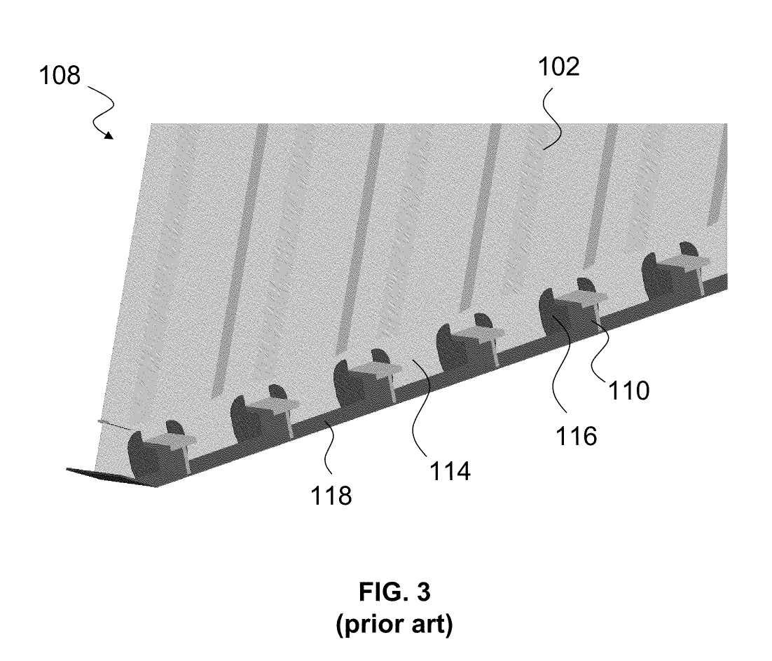

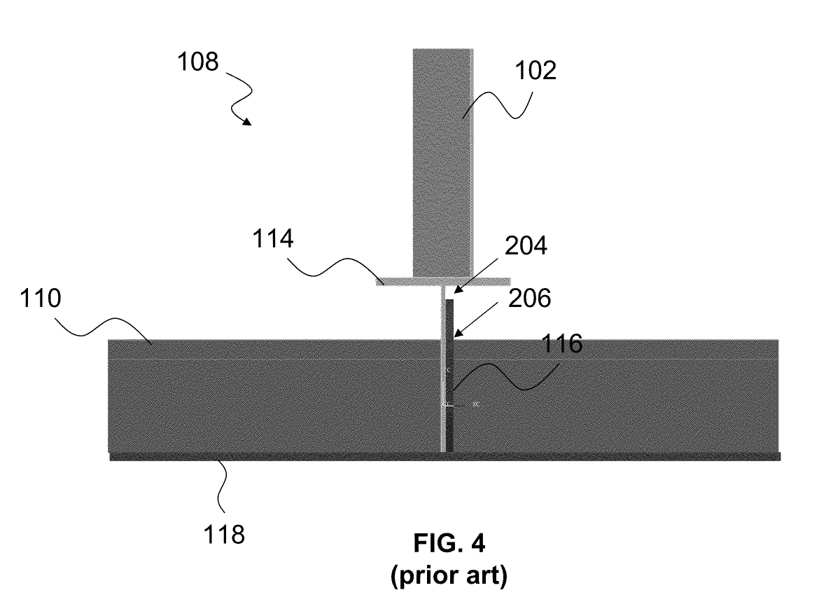

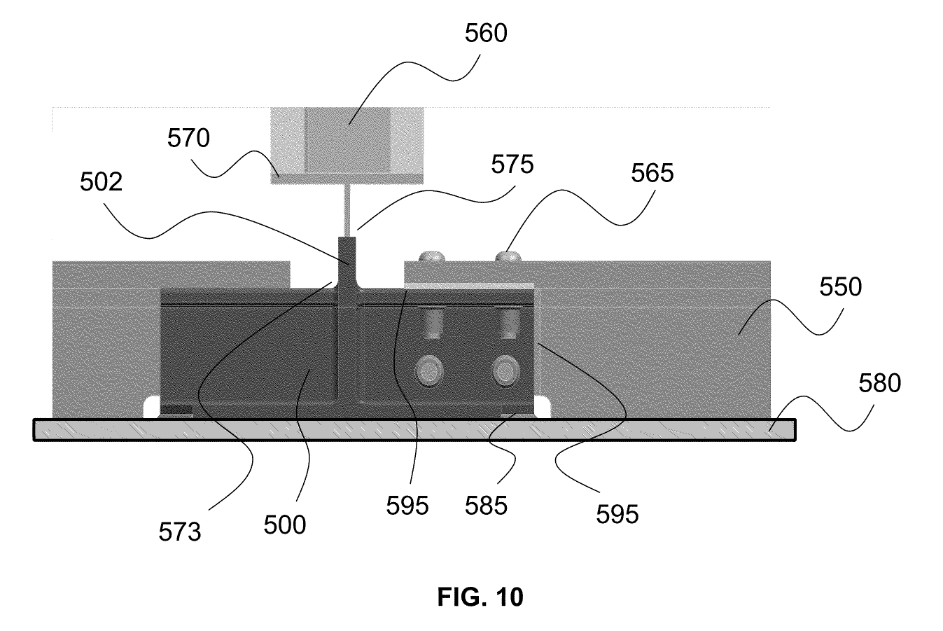

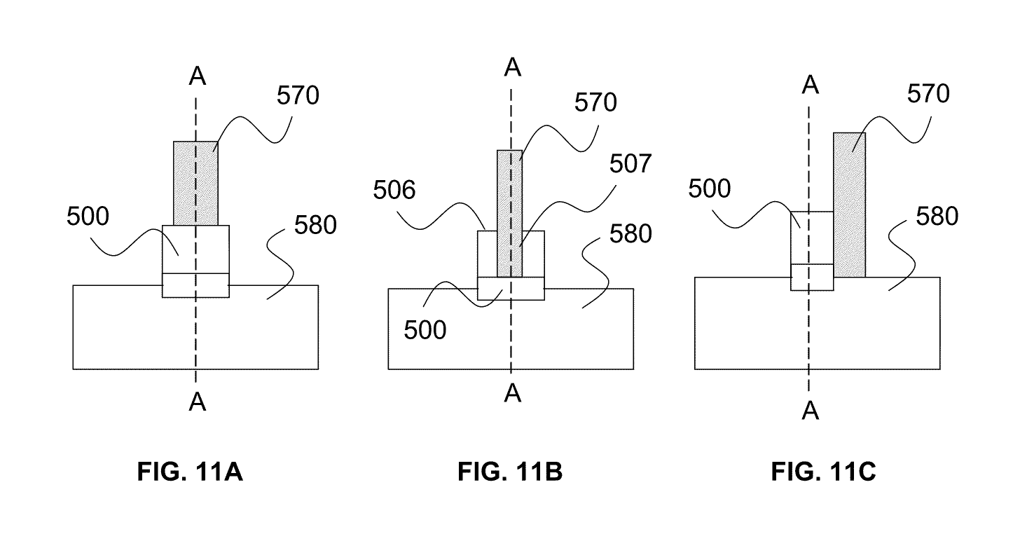

FIGS. 10-11 are cross-section views of the connector 500 and its relationship to the bulkhead base 570 and the hull 580 of the ship. In one embodiment, the body 502 of the structural connector 500 may be attached to the bulkhead base 570 as to allow smooth and continuous welds 575 to be formed therein between. In some instances, the continuous welds 575 may be friction stir or GMA welded square-butt joints. In other instances, the smooth transitions (e.g., large radius) 573 may minimize sharp and abrupt transitions between stringers 550 and the bulkhead base 570. In other words, the smooth transitions 573 may improve bending and fatigue resistance without the stress intensifying manual welds (e.g., sharp transitions) and weakened HAZs resulting from conventional connections (see FIGS. 1-4).

In some embodiments, the use of the structural connectors 500 may eliminate the need of sealing plates. Furthermore, weld junctures may be formed between the bulkhead base 570 and the stringers 550 that may be further away from the corrugated bulkhead 560 in contrast to the conventional approach thereby potentially mitigating weld-induced stress intensification at the connections between the bulkhead base 570 and the stringers 550.

As discussed above, stringers 550 may be coupled to the structural connector 500 using mechanical fasteners (e.g., huck-bolts) and/or GMA lap-fillet welds or both. In some embodiments, the combination of mechanical fasteners and GMA welds may be incorporated for joining the parts together. The joint redundancy may prevent the initiation of cracks and propagation in the welds during service or operation of the ship. In addition, the combination of joint and attachment techniques may afford joints that are stronger and more resistant to cyclic loading thereby providing added reliability during service.

Although the structural connector 500 may be attached to a substantially centerline A-A of the bulkhead base 570 as shown in FIG. 11A, in some embodiments, the centerline A-A about the interface surface 506 of the structural connector 500 may be shaped and sized to include a recess or slot 507 for receiving the bulkhead base 570 as shown in FIG. 11B, with the bulkhead base 570 being received by the connector 500 using a variety of fastening techniques similar to those described above including without limitation welding and bolting. In addition, instead of being coupled to the centerline A-A of the structural connector 500, the bulkhead base 570 may, in some instances, be received on one side of the structural connector 500 as illustrated in FIG. 11C. Like above, the bulkhead base 570 may be secured to one side of the structural connector 500 using any of the fastening techniques described above including welding and bolting, to name a few.

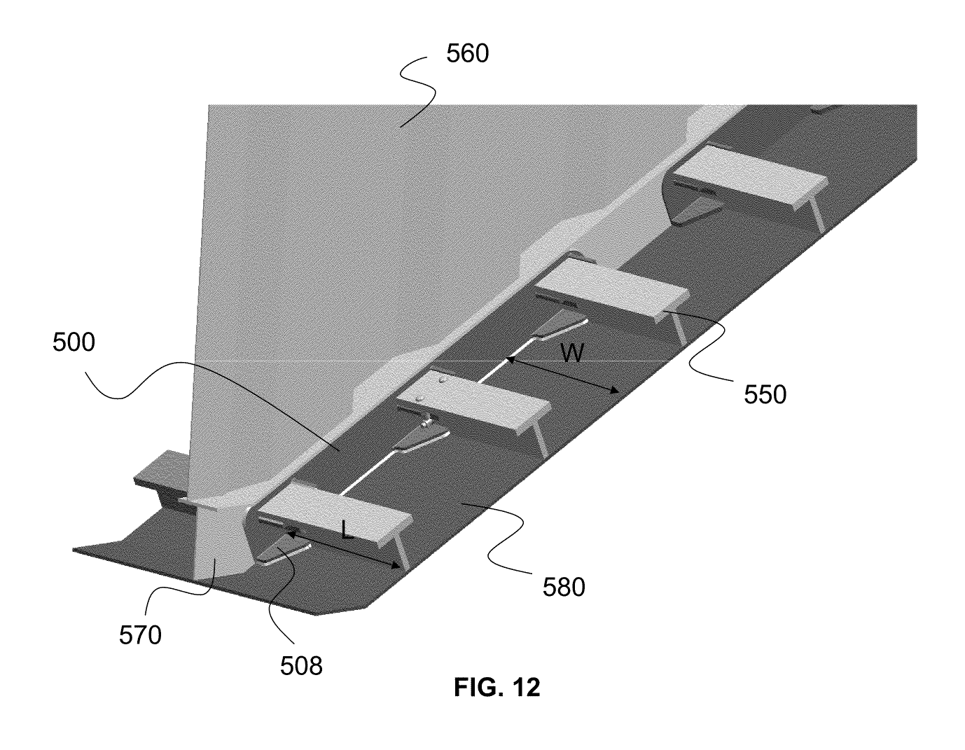

FIG. 12 is a perspective view of a structural connector 500 according to one embodiment of the present disclosure. As shown, the structural connector 500 may be attached to the bulkhead base 570, the corrugated bulkhead 560 and the hull 580 of the ship. In this instance, the structural connector 500 may be substantially similar to the structural connector 500 discussed above with the exception that the substrate 508 of the structural connector 500 is substantially triangular in shape as shown in FIG. 12. Also, in one embodiment, the length L of the stringers 550 may be positioned on the width W of the hull 580. Like above, the stringers 550 may be attached to the structural connector 500 via welding and bolting techniques, among others. In some embodiments, the types of weld joints that may be formed include weld butt joints, square butt joints, v-butt joints, lap joints and T-joints, among others. And similar to that described above, multiple stringers 550 may be longitudinally spaced with respect to each other and be fastened to the same structural connector 500. In some embodiments, the stringers 550 may be dropped into the recesses of the structural connectors 500 without any welds or bolts. In other embodiments, various combinations of spacings between stringers 550 and corresponding attachment to structural connectors 500 thereof may be anticipated.

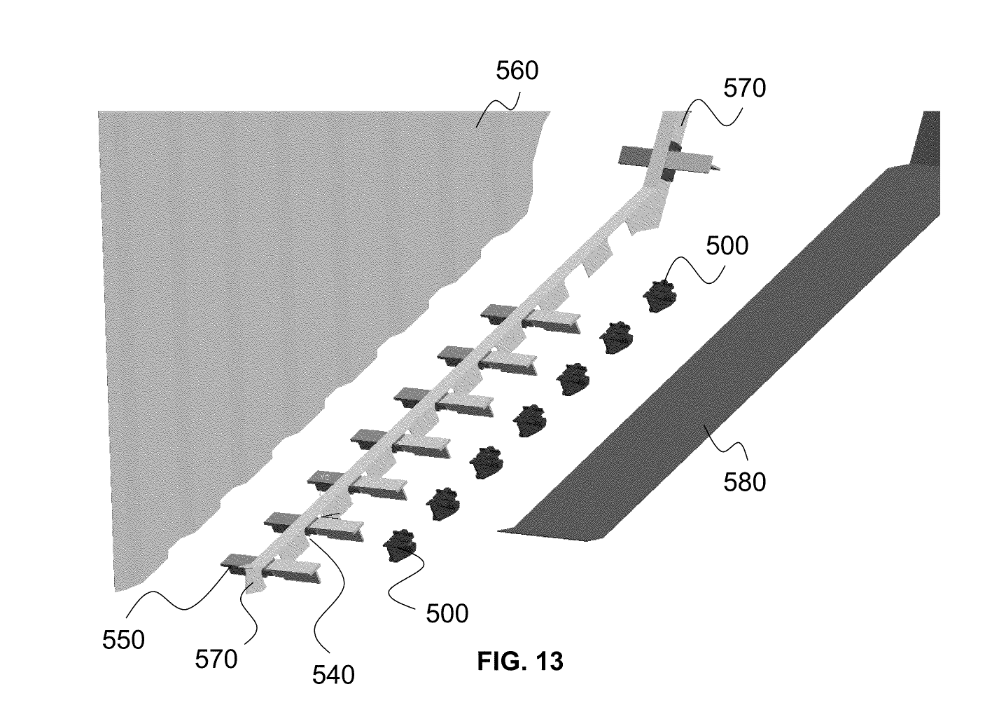

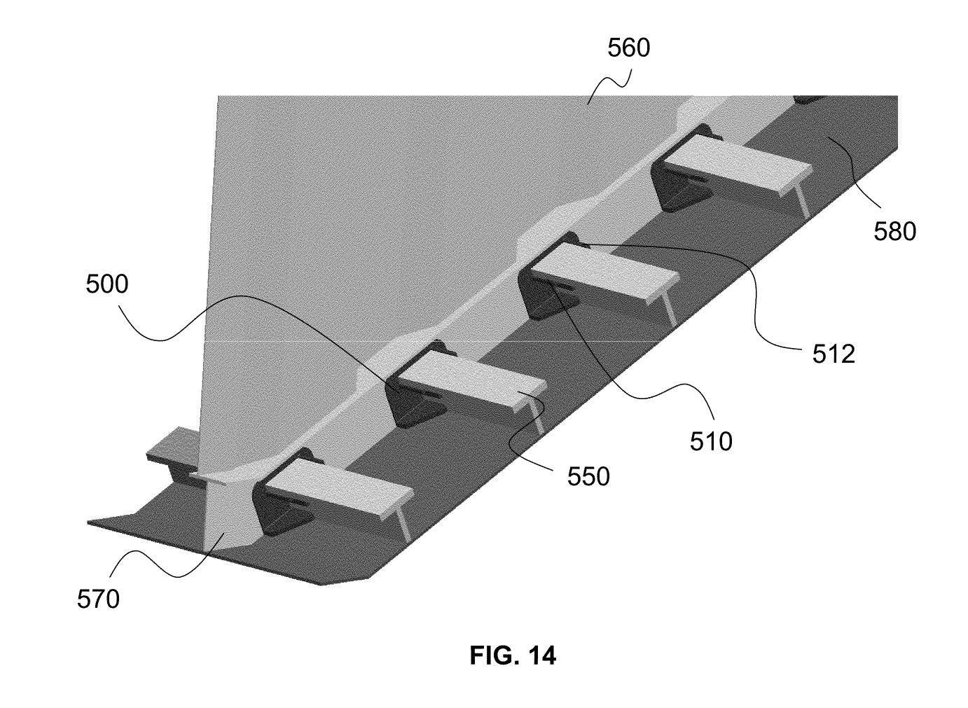

FIGS. 13-14 illustrate exploded and assembled views of a structural connector 500 attached to bulkhead 560, 570 and hull 580 of a watercraft for forming leak-proof compartments according to one embodiment of the present disclosure. In this instance, like above, the structural connector 500 may be attached to the corrugated bulkhead 560, the bulkhead base 570 and the hull 580 by welding or bolting or both. Alternatively, the structural connectors 500 may be coupled to the bulkhead 560, 570 and the hull 580 by other suitable coupling techniques including fasteners or adhesives, among others.

In the exploded view of FIG. 13, the bulkhead base 570 may include a plurality of openings 540 where each opening 540 may be designed to receive a structural connector 500. The structural connector 500 may be coupled within the opening 540 by the techniques described above including without limitation welding, bolt or attaching with fasteners or adhesives. In the assembled view of FIG. 14, the structural connector 500 may be received within the opening 540 by the coupling methods discussed above. Once situated therein, recesses 514 formed by members 510, 512 may be adapted to receive the stringers 550 of the ship. Like above, the stringers 550 may be welded or bolted to the structural connectors 500. Similar coupling techniques may be utilized for attaching the stringers 550 to the hull 580. In some instances, the stringers 550 may be attached to the structural connectors 500 and the hull 580 via other suitable coupling techniques. Unlike the structural connectors 500 shown in FIGS. 6-7, the structural connectors 500 in FIGS. 13-14 are shorter in length and configured to receive only one stringer 550 on each side of the structural connectors 500.

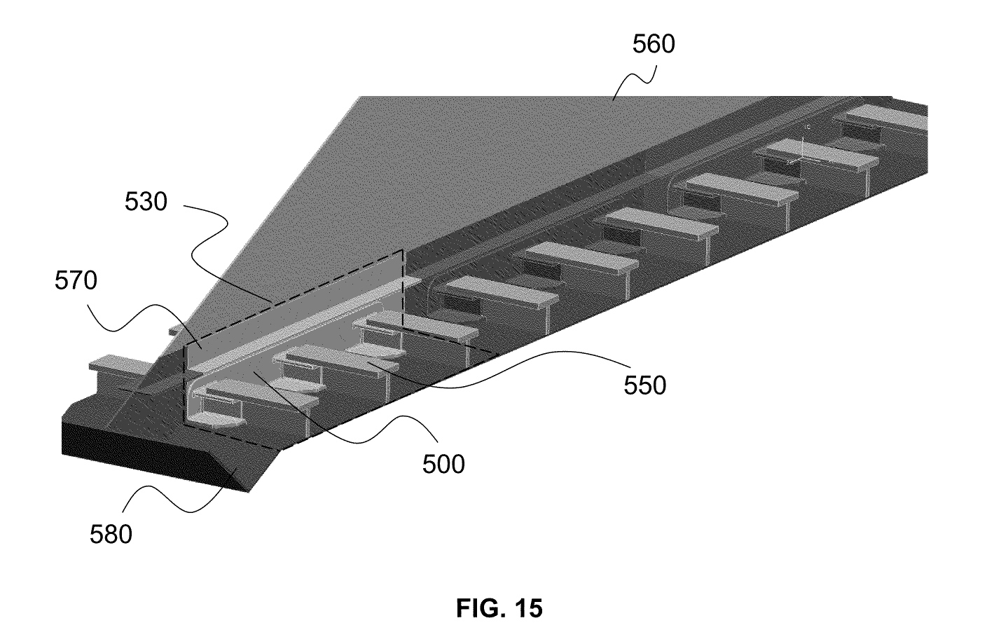

FIG. 15 is a perspective view of a structural connector module 530 (shown in dashed lines) attached to the bulkhead 560 and the hull 580 of a watercraft for forming leak-proof compartments according to one embodiment of the present disclosure. In this instance, the structural connector module 530 includes integrating structural connectors 500 with the bulkhead base 570 to form a single, unitary piece. The integrated module 530 may facilitate repair or fabrication processes of the watercraft. For example, damages to specific section of a ship may be replaced by removing the damaged module 530 and replacing the same with an undamaged module 530. In some embodiments, stringers 550 may also be integrated with the module 530. The structural connector modules 530 may be pre-fabricated for installation to a substantially flat bulkhead 560. In these instances, the friction stir or GMA weld square butt joints may be pre-formed as part of the module 530 prior to its installation on the ship.

Some of the benefits realized by the presently disclosed structural connectors for watercrafts include leak-proof welds to minimize or eliminate seepage of liquids (e.g., diesel fuel) between welds, along the stringers or across compartments and generally more reliable joints between the bulkheads, stringers and hull. In addition, the welds may be stronger because the overlapping HAZs of welds produced on opposite sides, as currently done, may be eliminated and the welding operation may be mechanized to minimize the human factor (e.g., manual welding) and its associated variability. The introduction of GMA welding square-butt joints may further reduce stress-rising effects of the lap and tee-fillet joints used with conventional connectors as GMA welded square-butt joints entail some of the lowest stress-intensification of all types of welded joints.

In some embodiments, the proposed structural connectors may be forged, cast and/or machined for different watercrafts. The structural connectors may be friction welded or GMA welded to portions (e.g., base, side) of bulkheads to form subassemblies (e.g., see FIG. 15 and corresponding discussion above) offsite prior to delivery to the watercraft onsite. Once the subassemblies are positioned in place, properly referenced and tack-welded to the ship, they may be GMA welded through square-butt joints to each other and to other parts of the ship. Concomitantly, the base of the subassemblies may be GMA welded to the hull of the ship. Optionally, stringers may be GMA welded to the hull of the ship. In some embodiments, stringers may be coupled to the subassemblies (e.g., recesses of the structural connectors) with mechanical fasteners (e.g., huck fasteners) or manual GMA welds or both techniques in the desired sequence and needed patterns.

Some of the advantages of the presently disclosed embodiments include better performance (e.g., stronger and improved fatigue life), leak-proof, and reliability in service and more cost effective approach for connecting bulkheads to stringers. Reduction in dependence on welding operator's skills and costly leak-proof tests and repair rates may also be realized. The structural connectors and the subassemblies may also be easier and safer to maintain and repair, even while the watercraft is at sea, as mechanical fasteners and/or GMA welds may be situated further from bulkheads and away from potentially explosive and flammable agents (e.g., diesel fuels). In other words, repairs may be performed to the fasteners and/or welds without coming into close proximity to the potentially explosive and flammable agents. Furthermore, the structural connectors and modules thereof may be cleaner and more controllable (e.g., dimensional tolerances and quality) that may lend themselves to more streamlined assembly of ships. The modules and subassemblies may also provide more value-added products to naval ships, commercial ships and portions of fuselages for the aerospace industry.

In addition to structural connectors and subassemblies for watercrafts, structural connectors for buildings and construction projects are also contemplated.

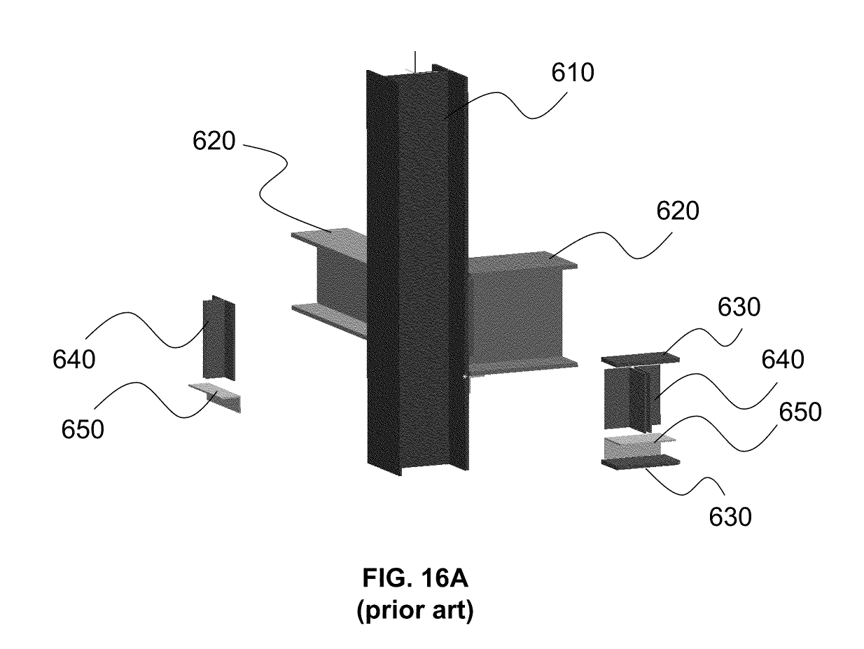

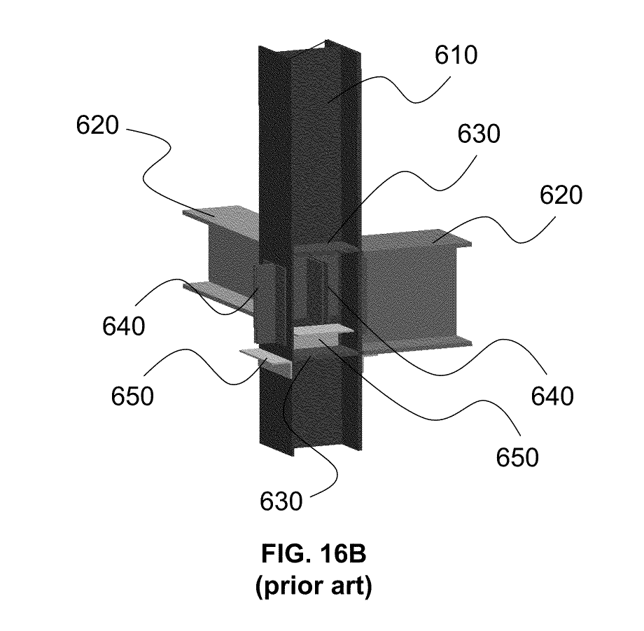

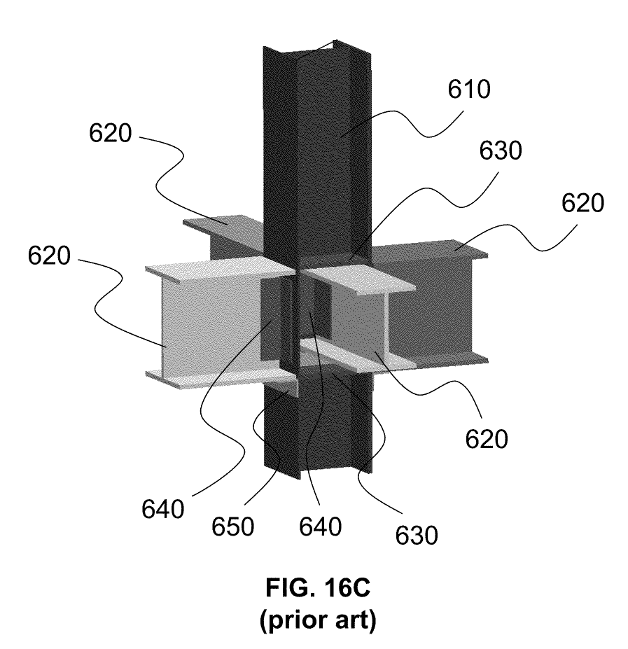

FIGS. 16A-16C illustrate some of the challenges associated with the conventional approach of connecting beams and columns of buildings. FIGS. 16A-16B are deconstructed and assembled views showing a process of attaching I-beams 620 to column 610. In this example, a plurality of parts may be required to facilitate the process. For instance, a pair of plates 640 may be spaced apart to form a recess therein between for receiving a portion of the I-beam 620. Once received within the recess, the weight of the I-beam 620 may be supported by angle clips 650. Additional support may be provided by joint plates 630. The plates 640, angle clips 650 and joint plates 630 may be attached to the column 610 via welding or bolting or fastening techniques similar to those discussed above. FIG. 16C is an assembled view showing the relationship among the plates 640, angle clips 650 and joint plates 630 and the beams 620. As shown, a portion of the I-beam 620 may be received within the recess created by the plates 640. Once received within the recess, the weight of the I-beam 620 may be supported by the angle clips 650. Additional support to further secure the I-beam 620 to the column 610 may be provided by a top joint plate 630. In some instances, bottom joint plates 630 may also be incorporated. The conventional method of joining beams 620 and columns 610 require several parts and components, and does not provide structural and functional continuity across the beams 620 and columns 610. Furthermore, gaps may be formed between cast or forged parts (e.g., plates 640, angle clips 650, joint plates 630) and techniques of securing the same parts to the column 610 thereby potentially causing structural issues (e.g., load distribution, load transfer) between the column 610 and the beam 620.

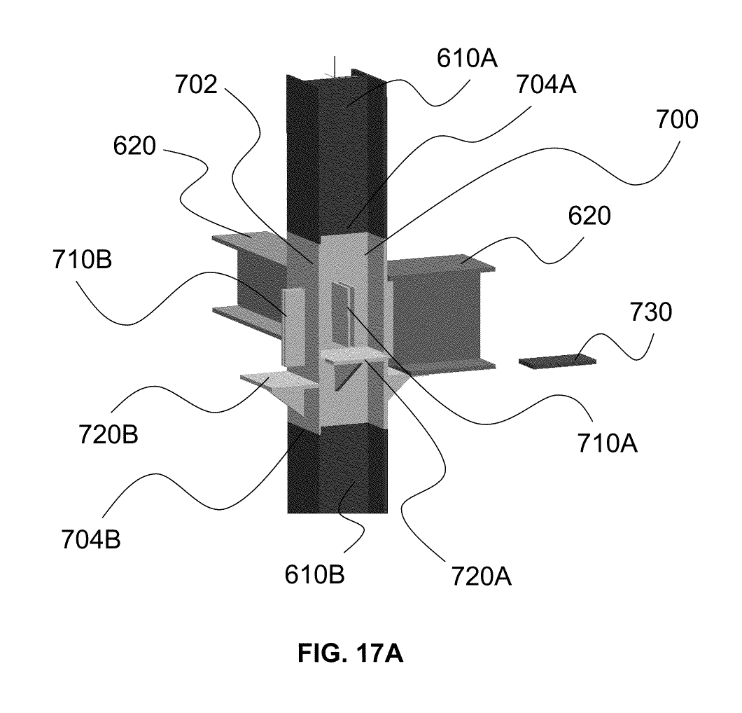

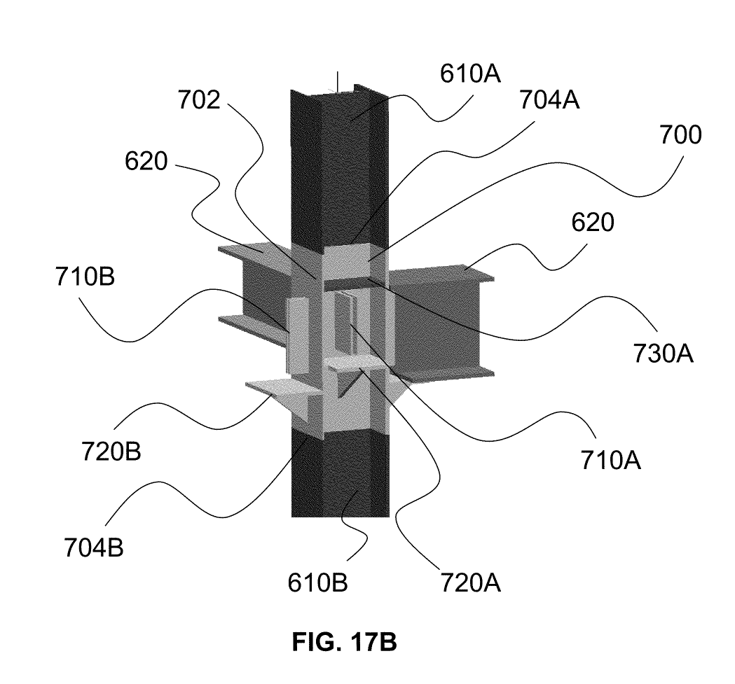

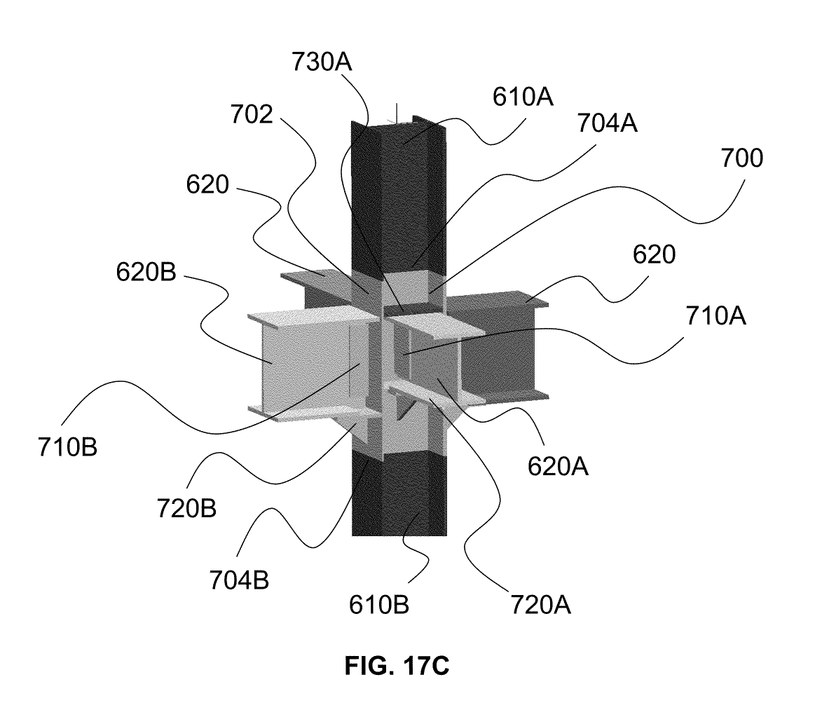

FIGS. 17A-17C illustrate structural connectors 700 for buildings according to one embodiment of the present disclosure. The structural connector 700 may be a unitary construction formed of a single piece to facilitate beam, column and girder connections for buildings and construction projects.

In one embodiment, the structural connector 700 includes a body 702 having a top surface 704A and a bottom surface 704B. As shown, the top surface 704A of the body 702 may be coupled to a support structure such as a column 610A while the bottom surface 704B of the body 702 may be coupled to another portion of a column 610B. In some embodiments, the surfaces 704 may be coupled to support structures such as girders and beams, among other support structures of a building. The surfaces 704 may be coupled to the columns 610 by welding or bolting or any of the attachment techniques discussed above.

In one embodiment, a pair of members 710A may extend outwardly from a first surface of the body 702, the pair of members 710A extending along substantially similar direction. In this instance, the members 710A may extend substantially perpendicular with respect to the body 702 of the connector 700. The members 710 may be attached to the first surface of the body 702 via coupling techniques similar to those described above including without limitation welding, bolting, fasteners, adhesives, or combinations thereof. The pair of members 710A may be spaced apart from one another so as to form a recess therein between. As shown, the members 710A have a substantially I-shape although other configurations including the likes of C-shape, L-shape, T-shape and planar shape, among others, may be entertained. The recess may be sized and shaped to receive a support structure 620A of a building as best shown in FIG. 17C. Adjacent the members 710A is a ledge 720A, which may also extend outwardly from and be substantially perpendicular with respect to the body 702. In one embodiment, the ledge 720A may be configured to support the weight of the support structure 620A. Although the ledge 720A as shown is substantially planar, the ledge 720A may also take on other configurations including C-shape, I-shape, L-shape, and T-shape, among others. In some embodiments, the bottom of the ledge 720A may include a gusset or other supporting devices.

Adjacent the first surface of the body 702 is a second surface, which may also have a pair of members 710B and corresponding ledge 720B extending outwardly from and being substantially perpendicular with respect to the second surface of the body 702. The members 710B and the ledge 720B may be configured to receive another support structure 620B of a building. Like the first pair of members 710A, the second pair of members 710B may be shaped to form a recess for receiving the support structure 620B while the ledge 720B may be adapted to support the weight of the support structure 620B.

In one embodiment, a cover or top plate 730 may be adapted to be coupled to the body 702 of the connector 700 and the support member 620A, with the top plate 730 being substantially adjacent the members 710A. For example, the top plate 730 may operably secure the support member 620A from rotating or slipping from the recess of the members 710A. Although not shown, it will be appreciated that another top plates may be attached to the neighboring support member 620B and the connector 700 to secure and prevent the support member 620B from rotating or slipping or both.

Although the body 702 of the connector 700 as shown has a substantially I-shaped cross-section, it will be appreciated that the body 702 may take on other polygonal shapes including the likes of C-shape, rectangular shape and square shape, among others. Accordingly, a plurality of members 710, ledges 720 and plates 730 may be attached to the body 702 of the connector 700 to facilitate structural and functional continuity of support structures 620 of buildings depending on the number of surfaces that may be available on the body 702 of the connector 700.

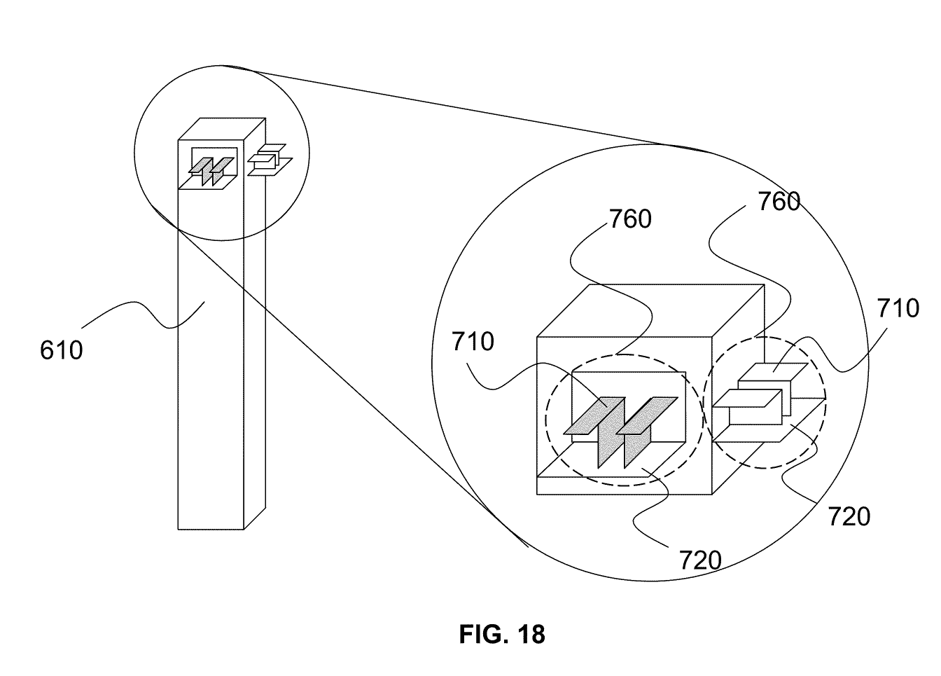

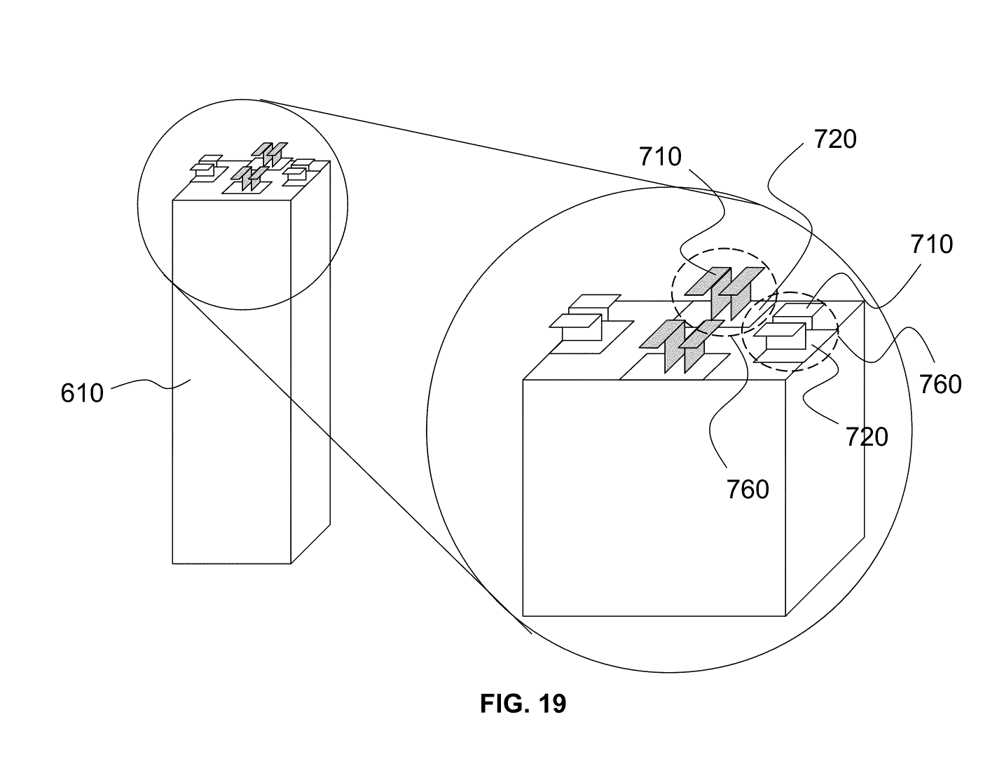

FIGS. 18-19 illustrate structural connector modules 760 for coupling beams, girders and columns of buildings according to one embodiment of the present disclosure. The modules 760 may be formed on the sides (FIG. 18) or top (FIG. 19) of a column 610 to facilitate coupling of the column 610 to other beams, girders or columns (not shown). In some embodiments, the modules 760 may be fabricated of aluminum, aluminum alloys or stainless steel, among other suitable materials. In other embodiments, the modules 760 may be cast, forged or machined.

In one embodiment, the module 760 includes members 710 configured to form a recess therein between similar to those discussed above, the recess configured to receive portions of beam, girder or column. Adjacent the members 710 is a ledge 720 for supporting the weight of the beam, girder or column. Optionally, the module 760 may also include plates for securing the beam, girder or column from slipping or rotating. The module 760 may be pre-fabricated and/or formed as a single unitary piece and attached accordingly to the column 610 using any of the coupling or fastening techniques described above.

Some of the benefits of the structural connectors include attaining structural and functional continuity, eliminating multiple parts for joining beams, columns and girders, eliminating gaps between cast or forged parts, maintaining and transferring load distributions from adjacent beams, and providing load compensation from adjacent beams through the structural connector.

In addition to structural connectors for watercrafts and buildings, structural connectors for aircrafts are also contemplated.

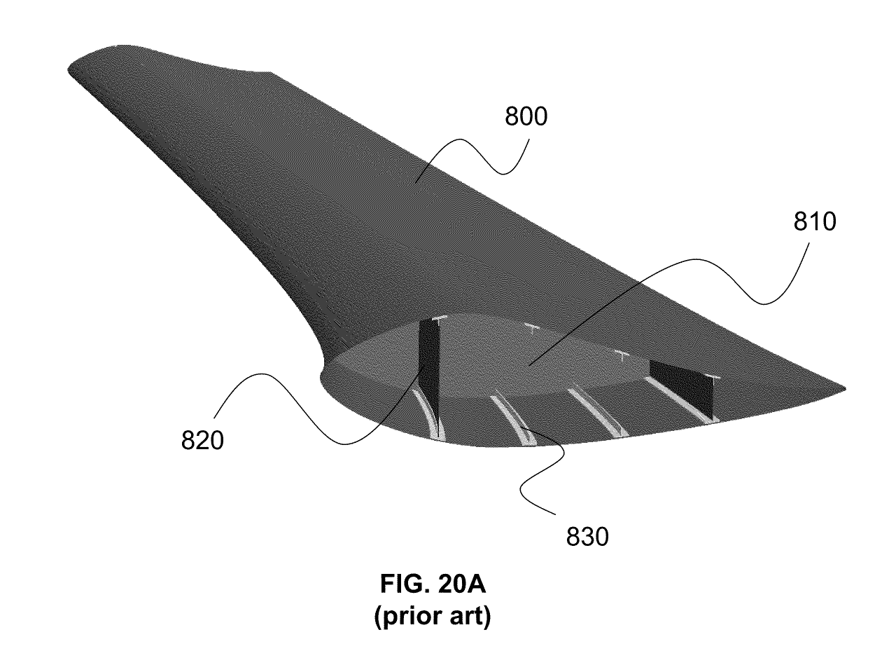

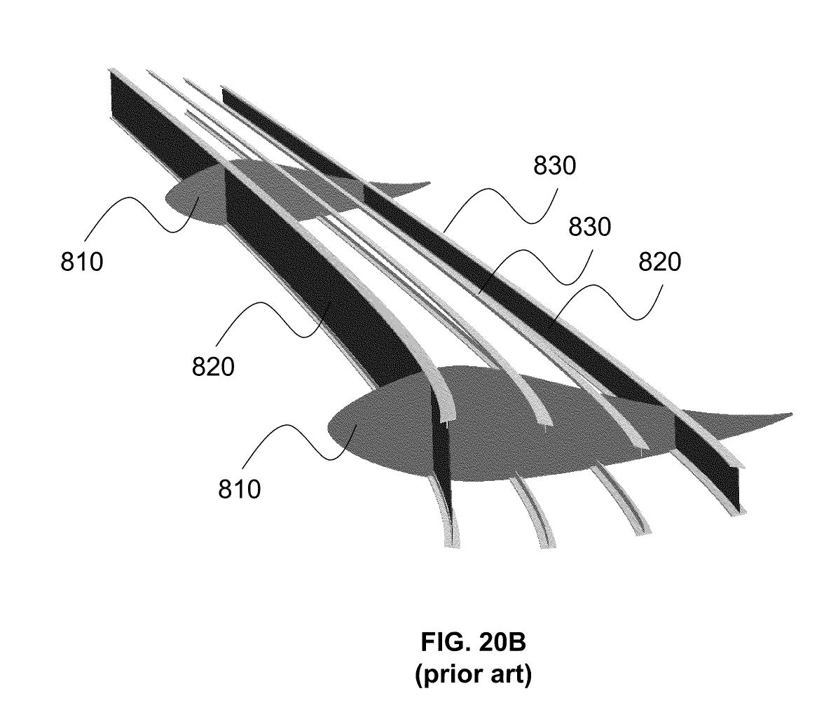

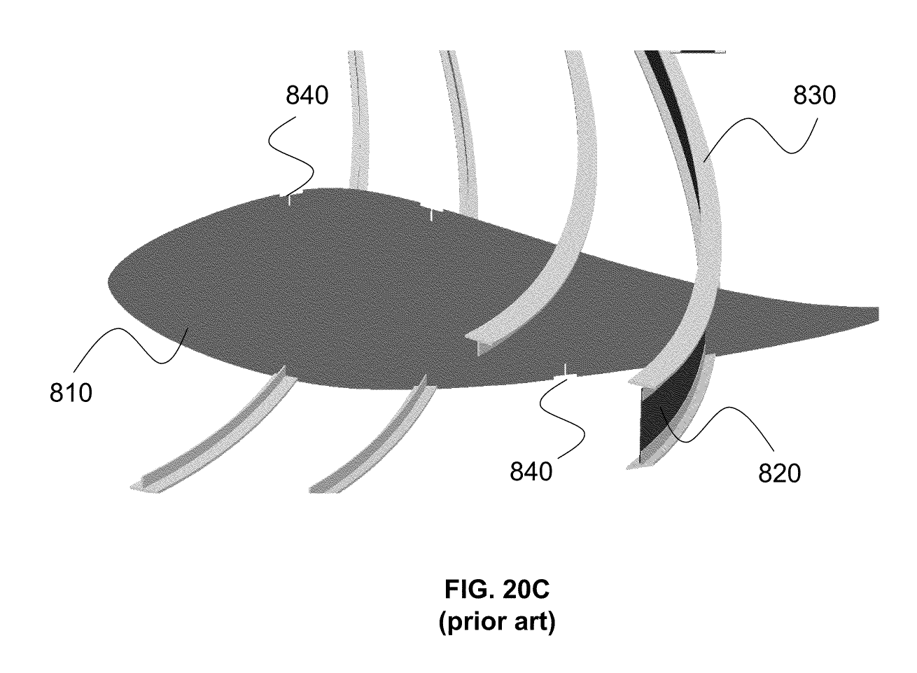

FIGS. 20A-20C illustrate some of the challenges associated with the convention approach of connecting stringers to support structures of aircrafts. FIG. 20A is an assembled, perspective view of an airplane wing having upper and lower skin panels 800 for forming box sections or compartments therein for storing fuel or other objects. The front and rear of the panels 800 may be closed off and web plates 810 and support plates 820 may be positioned within the enclosure of the panels 800 in constructing the compartments. To further support the plates 810, 820, stringers 830 including the likes of T-members, I-members and angle members may be attached to the plates 810, 820 and the panels 800 to provide stiffness to the compartment and to keep the wing from buckling during operation as illustrated in FIG. 20B. In some instances, it may be necessary to form notches 840 for receiving the stringers 830 as shown in FIG. 20C. Once situated therein, any gaps, holes or spaces between the stringers 830 and the notches 840 may need to be covered with clips, sealants, or adhesives, among other suitable fasteners, to prevent leaking between compartments or across the skin panels 800 of the aircraft. In other instances, it may be necessary to weld or bolt the stringers 830 to the notches 840 of the web plate 810 or the support plate 820, with the challenges associated with welding stringers being similar to those discussed above.

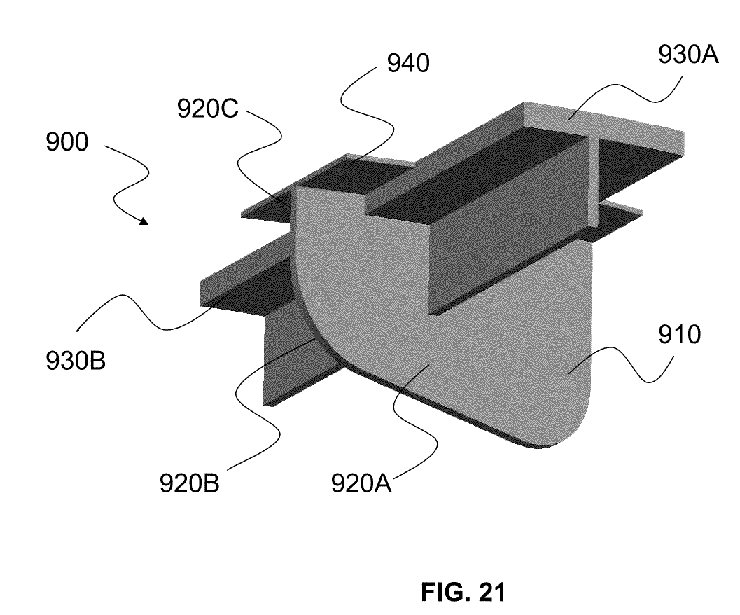

FIG. 21 illustrates an example of a structural connector 900 for forming leak-proof compartments of an aircraft such as an airplane. As shown, the structural connector 900 includes a body 910 having a first surface 920A, a second surface 920B opposite the first surface 920A, and an edge 920C intermediate the first surface 920A and the second surface 920B. In one embodiment, a portion of the edge 920C may be adapted to interface with a recess of a web plate 810 of an aircraft. This will become more apparent in subsequent figures and discussion.

As shown, a first member 930A may extend outwardly from and substantially perpendicular with respect to the first surface 920A of the body 910 along a first direction. In this instance, the first member 930A is extending substantially to the right of the body 910. In addition, a second member 930B may extend outwardly from and substantially perpendicular with respect to the second surface 920B of the body 910 along a second direction. In this instance, the second member 930B is extending substantially to the left of the body 910. In some instances, the second direction may be opposite the first direction and the position of the second member 930B may be opposite that of the position of the first member 930A. Although the members 930 as shown are substantially T-shaped, it will be appreciated that other shapes including C-shape, I-shape, L-shape, triangular shape, rectangular shape, among other shapes and configurations may be incorporated.

In some embodiments, each of the members 930A, 930B includes a free end that may be adapted to be coupled to first and second supporting members 830 of the aircraft such as stringers. In other words, the free end of the first member 930A may be welded to a first stringer while the free end of the second member 930B may be welded to a second stringer. The members 930 may also be bolted or fastened to the stringers 830 via any of the coupling techniques described above. This will become more apparent in subsequent figures and discussion.

Optionally, a structure 940 may be attached to a portion of the edge 920C, the structure 940 extending substantially perpendicular with respect to the body 910. In some embodiments, the structure 940 may be adapted to interface with the edge 920C via fasteners or adhesives or both. In other embodiments, the structure 940 may be adapted to interface with the edge 920C via welding or bolting or both. In some instances, the structure 940 and the edge 920C may be integrated as a single unit. In an engaged or coupled position, the structure 940 may be flush with the web plate 810 of the aircraft. This, too, will become more apparent in subsequent figures and discussion.

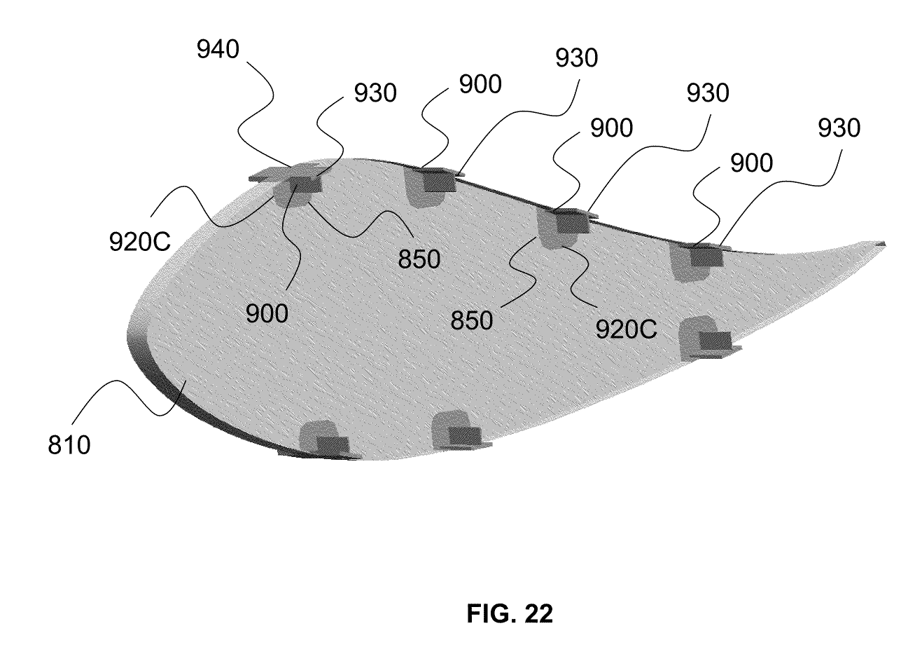

FIG. 22 illustrates an assembled view of the structural connector 900 of FIG. 21 to a web plate 810 of an aircraft. As shown, the connectors 900 may be received within recesses 850 disposed about portions of the web plate 810. In one embodiment, one portion of the edge 920C of the structural connector 900 may be securely received within the recess 850 of the web plate 810. The edge 920C of the structural connector 900 engaging the recess 850 of the web plate 810 may be further secured by attaching with fasteners or adhesive, or by welding or bolting. The structural connector 900 may be further attached to the web plate 810 by other suitable coupling techniques described above. Once received, the structure 940 or top plate of the connector 900 may be flush with respect to the outline of the web plate 810. In other words, in the engaged position where the structural connectors 900 are attached to the web plate 810, the upper surfaces of the connectors 900 may be substantially level with the exterior surface of the web plate 810 such that the assembly as shown in FIG. 22 may be covered with the skin panels 800 of the aircraft wing to produce leak-proof compartments. In addition, the ends of the member 930 may be free to engage support structures including stringers.

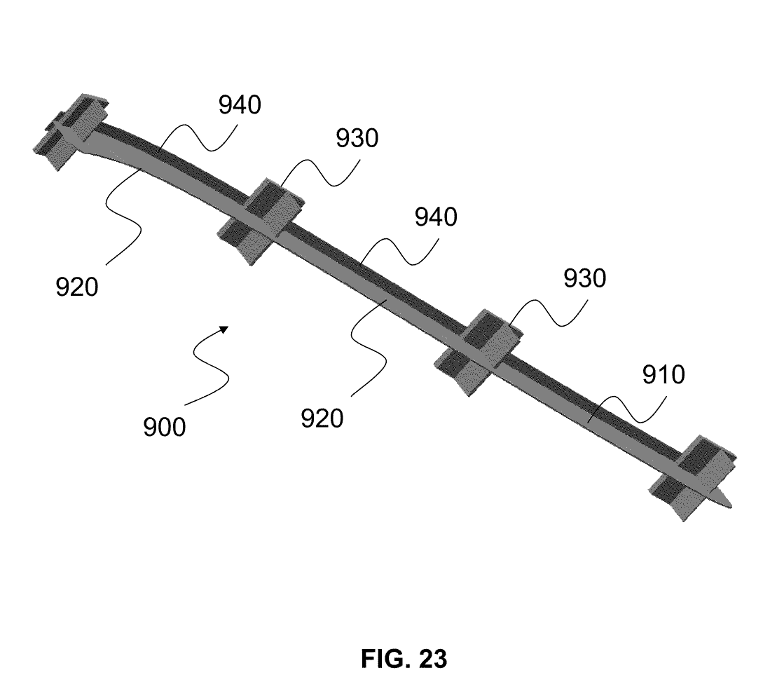

FIG. 23 illustrates another example of a structural connector 900 for forming leak-proof compartments of an aircraft such as an airplane. The structural connector 900, in this embodiment, includes an elongated body 910 having similar members 930 positioned about surfaces 920 of the body 910 at interval spacing. The structural connector 900 further includes a structure 940 that may be attached to an edge 920C, the structure 940 extending substantially perpendicular with respect to the body 910 and configured to be flush with the web plate 810 of the aircraft in an engaged position.

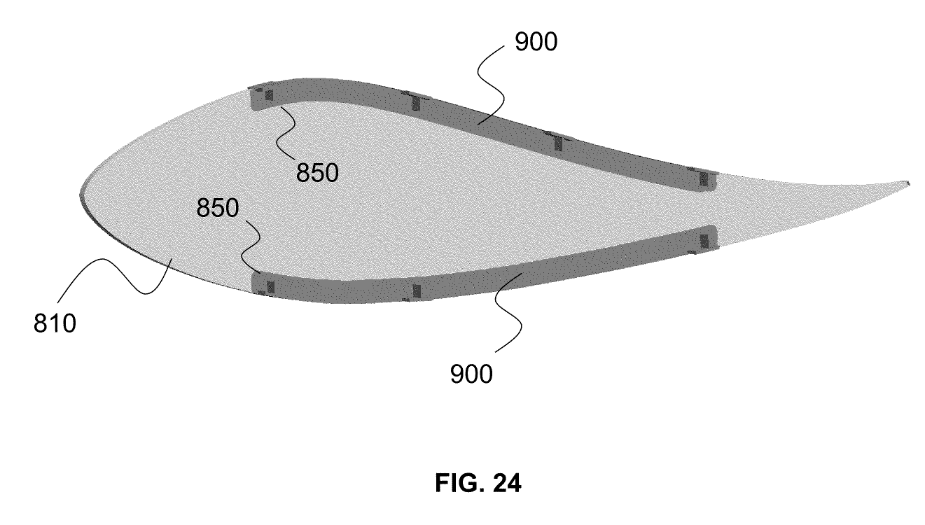

FIG. 24 illustrates an assembled view of the structural connector 900 of FIG. 23 to a web plate 810 of an aircraft. As shown, the connectors 900 may be received within recesses 850 on the upper and lower sides of the web plate 810. In contrast to FIG. 22, the recesses 850 in this example may be modified to accommodate the elongated body length of the structural connector 900. Like structural connectors for watercrafts, the number of opposing members 930 and the length and shape of the body 910 and the structure 940 may be adjusted accordingly to accommodate the shape and configuration of the web plate 810. In some instances, the numbers of members 930 and the length and shape of the body 910 and the structure 940 may be adjusted accordingly to accommodate the support structure (e.g., stringers) of the aircraft.

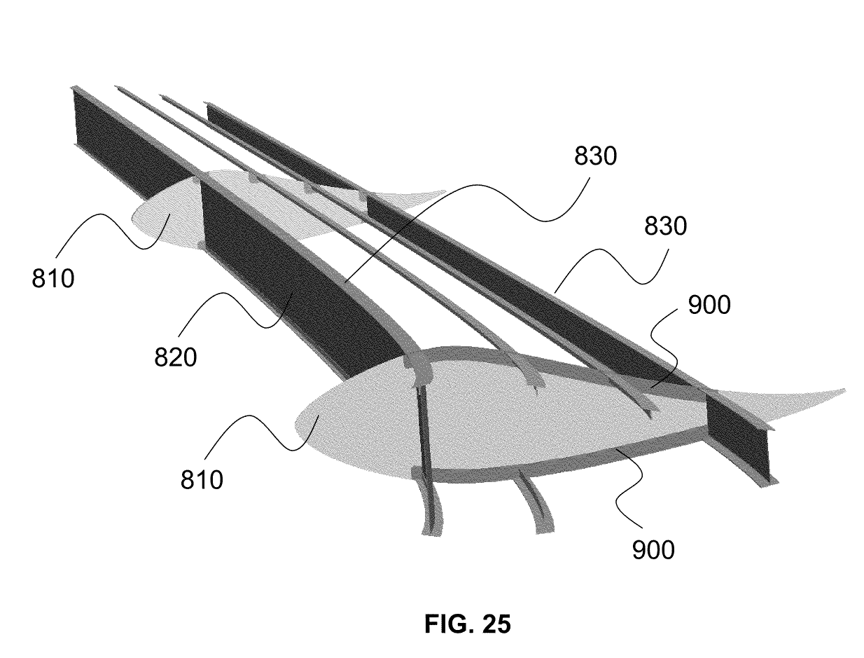

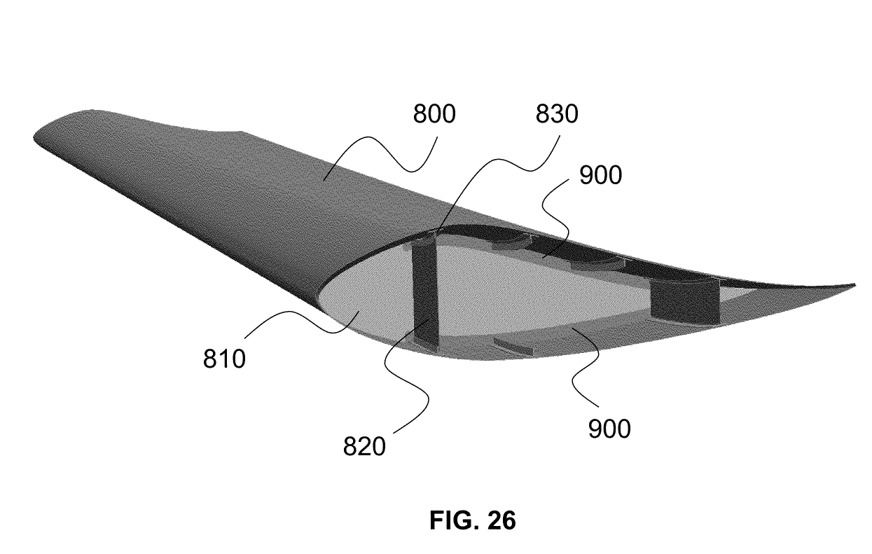

FIGS. 25-26 are assembled views of the structural connector 900 showing a wing of an aircraft with and without skin panels 800. As shown, once the structural connectors 900 have been securely received within recesses 850 of the web plates 810, the free ends of the members 930 may be attached to stringers 830 for additional structural support to the wing. The members 930 may be attached to the stringers 830 via the coupling techniques discussed above including without limitation welding, bolting, fastening with fasteners or adhesives. Likewise, support plates 820 may be similarly attached to the web plate 810 and the stringers 830. Furthermore, the skin panels 800 may be similarly coupled to the stringers 830. In some embodiments, the structural connectors 900 may be able to produce substantially leak-proof compartments by eliminating the need for filling gaps or spaces at junctions between recesses 850 of the web plate 810 and the stringers 830.

Although the disclosure has been described in detail with reference to several embodiments, additional variations and modifications exist within the scope and spirit of the disclosure as described and defined in the following claims.

What is claimed is:

1. A connector, comprising:
a body adapted to be coupled to a partition element of a watercraft;
a first member extending outwardly from and substantially perpendicular to the body in a first direction, and a second member extending outwardly from and substantially perpendicular to the body in the first direction, the first and second members being spaced apart from one another so as to form a first recess therein between, the first recess being sized and shaped for receiving a first supporting member of the watercraft;
a third member extending outwardly from and substantially perpendicular to the body in a second direction that is opposite the first direction, and a fourth member extending outwardly from and substantially perpendicular to the body in the second direction, the third and fourth members being spaced apart from one another so as to form a second recess therein between, the second recess being sized and shaped for receiving a second supporting member of the watercraft; and
a substrate extending substantially perpendicular to the body and the first, second, third and fourth members, and positioned to enclose a portion of each of the first and second recesses, the substrate being adapted to be coupled to a base of the watercraft.

2. The connector of claim 1, wherein the body includes a first surface, a second surface opposite the first surface, and an interface intermediate the first surface and the second surface, wherein the interface is welded to the partition element.

3. The connector of claim 2, wherein the first and second members are attached to the first surface and the third and fourth members are attached to the second surface.

4. The connector of claim 1, wherein the partition element is a bulkhead of the watercraft, and wherein the base is a hull of the watercraft, and wherein the first supporting member is a first stringer and the second supporting member is a second stringer.

5. The connector of claim 1, wherein each of the first, second, third and fourth members has at least one of L-shape, curved shape, rectangular shape and square shape.

6. The connector of claim 1, wherein the body is adapted to be coupled to the partition element by attaching with fasteners or adhesives or both, and wherein the substrate is adapted to be coupled to the base by attaching with fasteners or adhesives or both.

7. The connector of claim 1, wherein the body is adapted to be coupled to the partition element by welding or bolting or both, and wherein the substrate is adapted to be coupled to the base by welding or bolting or both.

8. The connector of claim 1, wherein the body is a first body and wherein the substrate is a first substrate, further comprising:
a second body longitudinally spaced to the first body, the second body adapted to be coupled to the partition element of a watercraft;
a fifth member extending outwardly from and substantially perpendicular to the second body in a third direction, and a sixth member extending outwardly from and substantially perpendicular to the second body in the third direction, the fifth and sixth members being spaced apart from one another so as to form a third recess therein between, the third recess being sized and shaped for receiving a third supporting member of the watercraft;
a seventh member extending outwardly from and substantially perpendicular to the second body in a fourth direction that is opposite the third direction, and an eighth member extending outwardly from and substantially perpendicular to the second body in the fourth direction, the seventh and eighth members being spaced apart from one another so as to form a fourth recess therein between, the fourth recess being sized and shaped for receiving a fourth supporting member of the watercraft; and
a second substrate extending substantially perpendicular to the second body and the fifth, sixth, seventh and eighth members, and positioned to enclose a portion of each of the third and fourth recesses, the second substrate being adapted to be coupled to the base of the watercraft.

9. A connector, comprising:
a body having a top surface and a bottom surface, wherein at least one of the top and bottom surfaces is adapted to be coupled to a first support structure of a building;
a first member extending outwardly from and substantially perpendicular to the body in a first direction, and a second member extending outwardly from and substantially perpendicular to the body in the first direction, the first and second members being spaced apart from one another so as to form a first recess therein between, the first recess being sized and shaped for receiving a second support structure of the building;
a first ledge positioned adjacent to the first and second members, the first ledge extending substantially perpendicular to the body, the first ledge adapted to support the second support structure;
a third member extending outwardly from and substantially perpendicular to the body in a second direction that is different than the first direction, and a fourth member extending outwardly from and substantially perpendicular to the body in the second direction, the third and fourth members being spaced apart from one another so as to form a second recess therein between, the second recess being sized and shaped for receiving a third support structure of the building; and
a second ledge positioned adjacent to the third and fourth members, the second ledge extending substantially perpendicular to the body, the second ledge adapted to support the third support structure.

10. The connector of claim 9, wherein the body comprises a first surface and a second surface different from the first surface, wherein the first ledge and the first and second members are attached to the first surface, and wherein the second ledge and the third and fourth members are attached to the second surface.

11. The connector of claim 9, wherein each of the support structures is a column, a girder or a beam.

12. The connector of claim 9, further comprising a plate adapted to be coupled to the body adjacent the first and second members, wherein the plate is operable to secure the second support structure from at least one of rotating and slipping.

13. The connector of claim 12, wherein the plate is a first plate, further comprising a second plate adapted to be coupled to the body adjacent the third and fourth members, wherein the second plate is operable to secure the third support structure from at least one of rotating and slipping.

14. The connector of claim 9, wherein the body has at least one of C-shape, I-shape, rectangular shape and square shape, and wherein each of the members and the ledges has at least one of C-shape, I-shape, L-shape, T-shape and planar shape.

15. The connector of claim 9, further comprising:
a first gusset adjacent the first ledge for supporting the first ledge; and
a second gusset adjacent the second ledge for supporting the second ledge.

16. A connector, comprising:
a body having a first surface, a second surface opposite the first surface, and an edge intermediate the first surface and the second surface, wherein a first portion of the edge is adapted to interface with a recess of a plate of an aircraft;
a first member extending outwardly from and substantially perpendicular to the first surface of the body in a first direction, and having a free end that is adapted to be coupled to a first supporting member of the aircraft;
a second member extending outwardly from and substantially perpendicular to the second surface of the body in a second direction that is opposite the first direction, and having a free end that is adapted to be coupled to a second supporting member of the aircraft, the second member being positioned opposite the first member; and
a structure extending substantially perpendicular to the body and adapted to interface with a second portion of the edge such that the structure is flush with the plate of the aircraft.

17. The connector of claim 16, wherein the free end of the first member is welded to the first supporting member and the free end of the second member is welded to the second supporting member, and wherein the first supporting member is a first stringer and the second supporting member is a second stringer.

18. The connector of claim 16, wherein each of the members has at least one of C-shape, I-shape, T-shape, L-shape, triangular shape and rectangular shape.

19. The connector of claim 16, wherein the first portion of the edge is adapted to interface with the recess by attaching with fasteners or adhesives or both; and wherein the structure is adapted to interface with the edge by attaching with fasteners or adhesives or both.

20. The connector of claim 16, wherein the first portion of the edge is adapted to interface with the recess by welding or bolting or both; and wherein the structure is adapted to interface with the edge by welding or bolting or both.
